(19) United States
(12) Patent Application Publication
(10) Pub. No.: US 2023/0226383 A1
(43) Pub. Date: Jul. 20, 2023

(54) METHOD AND APPARATUS FOR PERSONAL ISOLATION AND/OR PROTECTION

(71) Applicant: JustAir, Inc., San Francisco, CA (US)

(72) Inventors: Cory SYLLIAASEN, San Francisco, CA (US); Christina SKIELLER, San Francisco, CA (US); Derek HILLSTROM, San Francisco, CA (US); Daniel R. BURNETT, San Francisco, CA (US); Michael JAASMA, San Francisco, CA (US); Matthew SILVESTRINI, San Francisco, CA (US); Julie YIP, San Francisco, CA (US)

(73) Assignee: JustAir, Inc., San Francisco, CA (US)

(21) Appl. No.: 17/657,080

(22) Filed: Mar. 29, 2022

Related U.S. Application Data
(63) Continuation of application No. PCT/US2021/023734, filed on Mar. 23, 2021.
(60) Provisional application No. 62/994,137, filed on Mar. 24, 2020.
(60) Provisional application No. 63/007,871, filed on Apr. 9, 2020.
(60) Provisional application No. 63/025,736, filed on May 15, 2020.
(60) Provisional application No. 63/031,137, filed on May 28, 2020.
(60) Provisional application No. 63/056,782, filed on Jul. 27, 2020.
(60) Provisional application No. 63/118,354, filed on Nov. 25, 2020.
(60) Provisional application No. 63/136,905, filed on Jan. 13, 2021.
(60) Provisional application No. 63/141,698, filed on Jan. 26, 2021.
(60) Provisional application No. 63/145,909, filed on Feb. 4, 2021.

(51) Int. Cl. A62B 18/00; A62B 18/02; A62B 18/04; A62B 23/02

(52) U.S. Cl. CPC A62B 18/006; A62B 18/003; A62B 18/02; A62B 18/045; A62B 23/02; A62B 7/10

(57) ABSTRACT

Method and apparatus for personal isolation and/or protection are disclosed. In one variation, the system may include a passive filtration component having a mask configured for positioning over a mouth and/or nose of a user, wherein the mask has at least one portion configured to filter air passing through the at least one portion. An active filtration component having a fan may be included, wherein the active filtration component is configured to filter air entering or exiting the active filtration component via the fan, and a hose fluidly coupled between the passive filtration component and the active filtration component such that the active filtration component is remote from a face of the user when in use.

### CROSS-REFERENCE TO RELATED APPLICATIONS

This application is a continuation of PCT/US2021/023734 filed Mar. 23, 2021, which claims the benefit of priority to U.S. Prov Applications 62/994,137 filed Mar. 24, 2020; 63/007,871 filed Apr. 9, 2020; 63/025,736 filed May 15, 2020; 63/031,137 filed May 28, 2020; 63/056,782 filed Jul. 27, 2020; 63/063,663 filed Aug. 10, 2020; 63/118,354 filed Nov. 25, 2020; 63/136,905 filed Jan. 13, 2021; 63/141,698 filed Jan. 26, 2021; 63/145,909 filed Feb. 4, 2021, each of which is incorporated herein by reference in its entirety.

### FIELD OF THE INVENTION

The present invention relates generally to the stimulation of bone growth, healing of bone tissue, and treatment and prevention of osteopenia, osteoporosis, cartilage and chronic back pain, and to preserving or improving bone mineral density, and to inhibiting adipogenesis particularly by the application of repeated mechanical loading to bone tissue.

### INCORPORATION BY REFERENCE

All publications and patent applications mentioned in this specification are herein incorporated by reference to the same extent as if each such individual publication or patent application were specifically and individually indicated to be so incorporated by reference.

### BACKGROUND OF THE INVENTION

The present invention relates to the field of medical devices, in particular personal isolation and/or protection devices to reduce the risk of airborne illness transmission.

Prior to the present invention, various isolation devices have been contemplated, including passive face masks, gas masks and some tent-based devices. For the purposes of traveling where one will frequently interact with others and be exposed to their secretions, the face and gas masks may be either too bulky or ineffective and the tent-based devices may not be practical. Therefore, there exists a strong need, particularly in light of the upcoming flu epidemic, for a less obtrusive, more effective personal isolation system.

### SUMMARY OF THE INVENTION

The device of the present invention may create and maintain a pressure differential in the vicinity of the user's nose and/or mouth. Using a portable filter and pressurized air source, the region of the user's nose and/or mouth can be subjected to positive or negative pressured air. Positive pressure will prevent exposure to surrounding air while negative air pressure will isolate those around the user from potential toxins or pathogens exhaled from the user. In the positive pressure embodiments, the surrounding air may be displaced by the positive pressure environment preventing exposure to ambient air. In the negative pressure embodiment, exhaled air may be evacuated from the nose and/or mouth, filtered and returned to the user's surroundings to prevent exposure to those around the user. The device of the present invention may be incorporated into a variety of garments, accessories or existing isolation devices (i.e. face masks) to improve their efficacy. Alternatively, the device may also be attached to an air source in the user's vicinity and simply provide filtration of the air prior to delivery to the region surrounding the user.

In the positive pressure embodiment, the positive pressure and/or repelling force could be generated by a variety of mechanisms, but in its preferred embodiment includes a filter (for example a HEPA filter), a fan (or pressurized air source), a head and/or neck worn garment to direct the airflow to create the localized positive pressure region and optional tubing to channel air flow if the fan/filter is not incorporated directly into a head or neck worn garment. The device may be powered by battery or by direct connection (wired) to an energy source, such as a USB or electrical outlet.

A HEPA (High Efficiency Particulate Air) filter is defined as an air filter which removes from the air that passes through it at least 99.95% (European Standard) or 99.97% (ASME, U.S. DOE) of particles whose diameter is equal to 0.3 μm; with the filtration efficiency increasing for particle diameters both less than and greater than 0.3 μm.

The device may be used in combination with a face mask to increase its efficacy, as well, by creating a positive pressure environment between the face mask and the nose and/or mouth to prevent ambient air and water droplets from passing around the edges of the mask into the user's lungs.

Lastly, in the airplane embodiment or in any area where a pressurized air source is available, the device may consist of a filter which may be reversibly or irreversibly attached to the pressurized air source to generate a localized positive pressure region of sterilized air. This embodiment may be used in combination with a partial or full canopy, as well, in order to increase the local positive pressure generation around the user.

Alternatively, particularly for air and other forms of travel, the device of the present invention could also be modified to provide for isolation of the user's surrounding from the users exhaled air. In this embodiment, capable of being used with a face mask as well, the filtration mechanism may draw air from the region of the patient's nose and/or mouth creating a localized region of negative pressure to prevent transmission of exhaled particles from the user to anyone in their vicinity. This embodiment may be used in a variety of applications, as well, with quarantine of infected traveling individuals and prevention of transmission of pathogens from visitors to immunocompromised patients being two robust applications. In this way, the use of a portable negative pressure isolation system, the user need not worry about infecting or exposing individuals in their vicinity.

One variation of a personal isolation system may generally comprise a passive filtration component having a mask configured for positioning over a mouth and/or nose of a user, wherein the mask has at least one portion configured to filter air passing through the at least one portion. An active filtration component having a fan may be included, wherein the active filtration component is configured to filter air entering or exiting the active filtration component via the fan, and a hose fluidly coupled between the passive filtration component and the active filtration component such that the active filtration component is remote from a face of the user when in use.

One variation of a method of filtering air may generally comprise positioning a passive filtration component having a mask over a mouth and/or nose of a user, wherein the mask has at least one portion configured to filter air passing through the at least one portion, positioning an active filtration component having a fan remote from a face of the user, wherein the active filtration component is configured to filter air entering or exiting the active filtration unit, and actuating the active filtration component such that air is passed between the active filtration component and the passive filtration component via a hose fluidly coupled between.

### BRIEF DESCRIPTION OF THE DRAWINGS

FIG. 1 is a perspective view of the cap-worn embodiment of the present invention.

FIG. 2 is a perspective view of the neck-worn embodiment of the present invention.

FIG. 3 is a perspective view of the combination cap- and neck-worn embodiment of the present invention.

FIG. 4 is a perspective view of the positive pressure filtration cap embodiment of the present invention illustrated in an air travel setting.

FIG. 5 is a perspective view of the positive pressure filtration cap embodiment of the present invention illustrated in an air travel setting with the optional canopy for improved positive pressure isolation.

FIG. 6 is a perspective view of a full outdoor protection system including possible radiation exposure protection, positive pressure isolation and/or evaporative cooling.

FIG. 7 is a perspective view of one embodiment of the present invention used in combination with a standard face mask to increase effective isolation.

FIG. 8 shows an embodiment of the isolation system which has been incorporated into either functional headphones, or a device which resembles headphones.

FIG. 9 shows an embodiment of the headphone isolation device where the air source/filter is controlled by a mobile phone.

FIG. 10 shows an embodiment of the isolation device in use on a user.

FIG. 11 shows an embodiment of the isolation device used with the addition of a face mask.

FIG. 12 shows an embodiment of the vent.

FIG. 13 shows another embodiment of the vent.

FIG. 14 shows another embodiment of the vent.

FIG. 15 shows another embodiment of the vent.

FIG. 16 shows an embodiment of the isolation device which has been incorporated into eyewear.

FIG. 17 shows the isolation device of FIG. 16 in use.

FIG. 18 shows the isolation device of FIG. 16 in sue in conjunction with a face mask.

FIG. 19 shows an embodiment of the isolation device incorporated into a travel pillow.

FIG. 20 shows the embodiment of FIG. 19 in use.

FIG. 21 shows an embodiment of the isolation device which is incorporated into, or can be added to, the collar of a garment, such as a jacket or shirt.

FIG. 22 shows an embodiment of the isolation device which is incorporated into a mask.

FIG. 23 shows an embodiment of the air source/filter.

FIG. 24 shows an embodiment of the isolation device which is designed for the nostrils.

FIG. 25 is a block diagram of a data processing system.

FIGS. 26 and 27 show embodiments of the isolation device which includes both inhalation and exhalation ports as part of a mask.

FIG. 28 shows an embodiment of the isolation device which provides both pressurized air, through the inhalation tubing, and negative pressure, via the exhalation tubing.

FIG. 29 shows an embodiment of the isolation device with a positive pressure line and no exhalation line.

FIGS. 30 and 31 show embodiments of the isolation device which include a sensor on the chest, to monitor breathing.

FIG. 32 shows an embodiment of the isolation system which incorporates the exhalation line into the mask.

FIG. 33 shows an embodiment similar to that shown in FIG. 32.

FIGS. 34 and 35 show another embodiment of the isolation system.

FIGS. 36A-C show another embodiment of the isolation system.

FIGS. 37A and 37B show more views of the embodiment of the isolation system shown in FIG. 36.

FIGS. 38A and 38B show other views of the isolation device shown in FIGS. 36 and 37A and 37B.

FIGS. 39A and 39B show other views of the isolation device.

FIGS. 40A and 40B show other views of the isolation device.

FIGS. 41A-C show more detail around the controller and/or air supply/filter.

FIGS. 42A and 42B show another embodiment of the isolation system.

FIGS. 43A and 43B show additional views of the embodiment shown in FIG. 42.

FIGS. 44A-C show more detail around the controller and/or air supply/filter.

FIGS. 45A-C show another embodiment of the isolation system.

FIGS. 46A and 46B show the embodiment of FIG. 45 close up.

FIGS. 47A and 47B show other views of the embodiment shown in FIG. 45.

FIGS. 48A and 48B show the isolation system in use with and without eyewear.

FIGS. 49A and 48B show an embodiment of the isolation system with a detachable/attachable face shield.

FIGS. 50A-C show more detail around a connecter.

FIGS. 51A-C show an additional variation of a support.

FIGS. 52A-C show an embodiment of the isolation device with a mechanical connection.

FIGS. 53A-D show some considerations and lengths for the filtered air supply hose.

FIG. 54 shows some examples of extendable/compressible hoses, which may be adjusted to different lengths.

FIG. 55 shows an example of the controller/air supply/filter

FIG. 56 shows the controller/air supply/filter of FIG. 55 with the case cover removed.

FIG. 57 shows an example of a connector between the controller/air supply/filter and a strap

FIGS. 58A-C show some different hose lengths for different device placement scenarios.

FIGS. 59A-D show some example steps that may be used to donning and starting the device.

FIGS. 60 and 61 show an example of the controller/air supply/filter.

FIGS. 62A-C show some different hose lengths for different device placement scenarios.

FIGS. 63A-D show some example steps that may be used to donning and starting the device.

FIGS. 64A-F show some different routing of the supply tube(s).

FIGS. 65A and 65B shows other embodiments of the isolation device.

FIG. 66 shows the embodiment of the isolations system shown in FIG. 65 as worn by the user.

FIGS. 67A-C show detail of the mask are of the embodiment shown in FIGS. 65 and 66.

FIGS. 68A and 68B show a detail view of the elbow connector.

FIGS. 69A and 69B show a detail view of the flange.

FIG. 70 shows the mask connected to the hoses.

FIG. 71 shows the air feed tube connected to the controller/filter.

FIG. 72A shows a filter, such as a filter that may be placed inside the filter pack.

FIG. 72B shows another view of a mask.

FIG. 72C shows another view of the hose assembly.

FIG. 73A shows another embodiment of the isolation system.

FIG. 73B shows an expanded view of the embodiment shown in FIG. 73A.

FIGS. 74A-74I show the donning process for the embodiment shown in FIG. 73A.

FIGS. 75A-C show detail of the loop component of this embodiment.

FIGS. 76A and 76B show detail of the eye shield, face shield and filter of some embodiments.

FIG. 77 shows details of the face shield and face shield filter of this embodiment.

FIGS. 78A-D show details of the mini module/controller/filter of this embodiment.

FIGS. 79A-D show more details of the mini module/controller/filter of this embodiment.

FIG. 80 shows the function of the loop component of this embodiment.

### DETAILED DESCRIPTION OF THE DRAWINGS

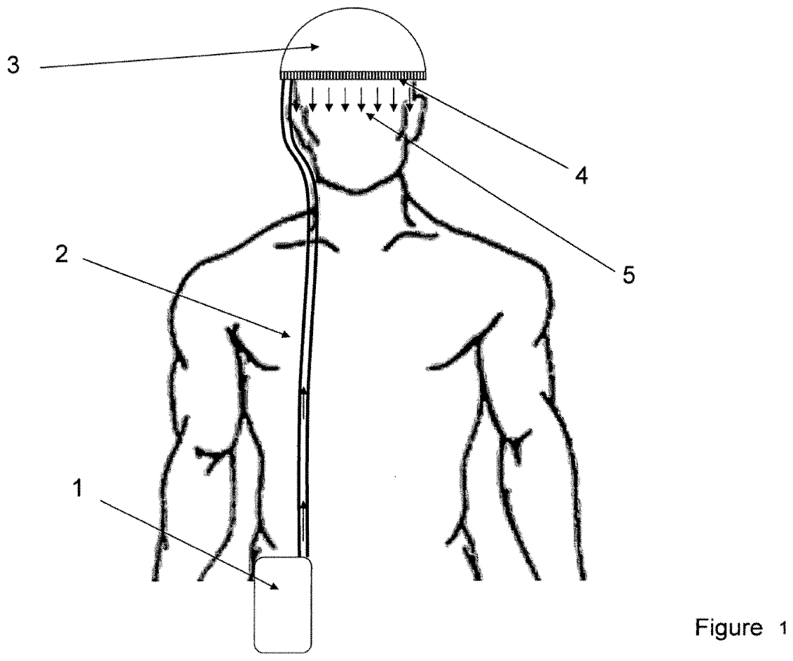

Embodiments of the isolation device may include a portable, air filter capable of generating a localized pressure differential in the region of the user's nose and/or mouth. As can be seen in FIG. 1, the device may consist of an air filter/air source 1 which may or may not be in a single unit. The air filter/air source may be part of a controller. The device may further consist of optional tubing 2 and air channels 4 to create pressure differential 5 in the region of the user's nose and/or mouth. In FIG. 1, an embodiment is illustrated wherein said device utilizes a head worn garment 3, to focus the positive pressure to the region of the user's nose and/or mouth. In this case, and with all other embodiments, while only one pressure differential is illustrated (in this case positive pressure) the opposite differential may also be used (i.e. negative pressure). The air filter/air source may be separate from garment 3 or incorporated into the garment. The air filter/air source may be battery powered, or powered by a hard wire to a power source.

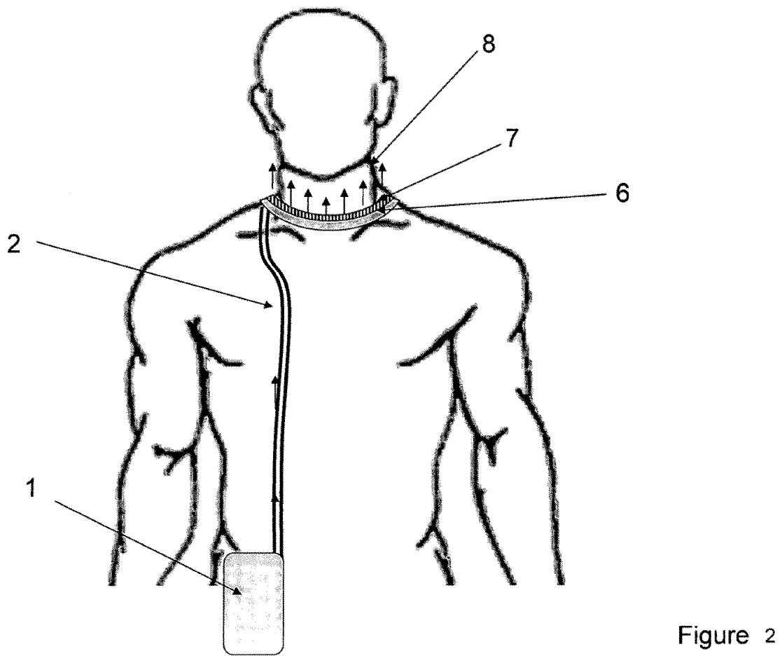

FIG. 2 illustrates an alternative embodiment wherein the filtered air is channeled to the nose and/or mouth via a neck-worn garment 6 which in turn uses air channels 7 to create a pressure differential in the region of the nose and/or mouth 8. In this case, as well, only the positive pressure differential is illustrated although a negative pressure differential may alternatively or also be used.

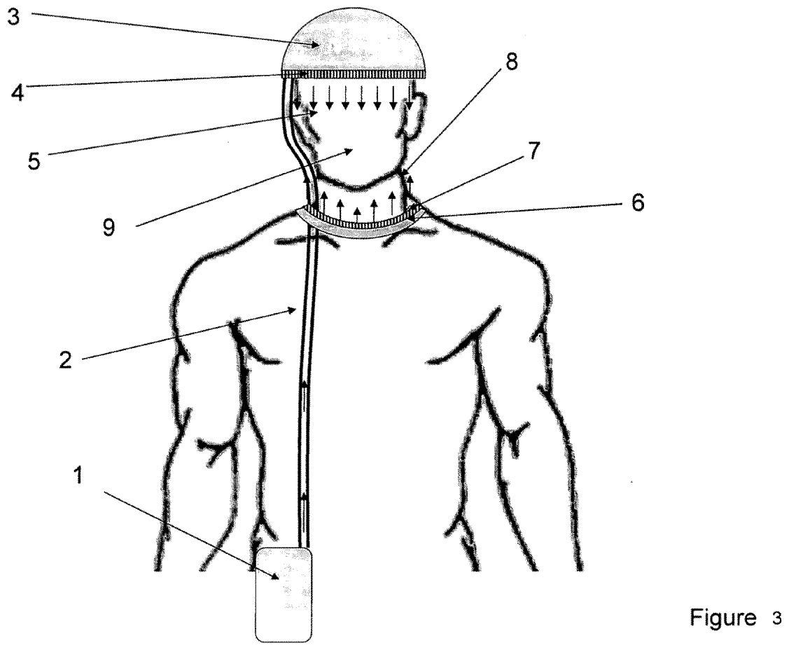

FIG. 3 illustrates an embodiment wherein both the head—3 and neck—6 worn embodiments are used in order to create a pressure differential 9 in the region of the nose and/or mouth.

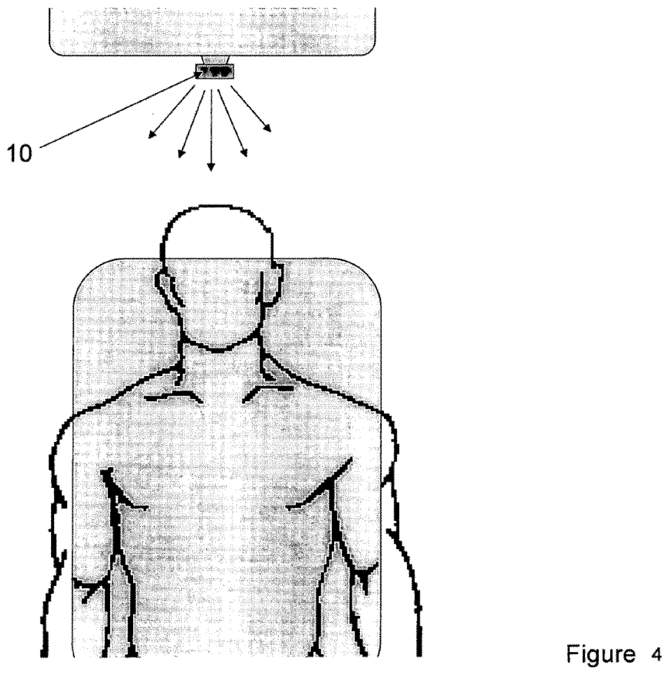

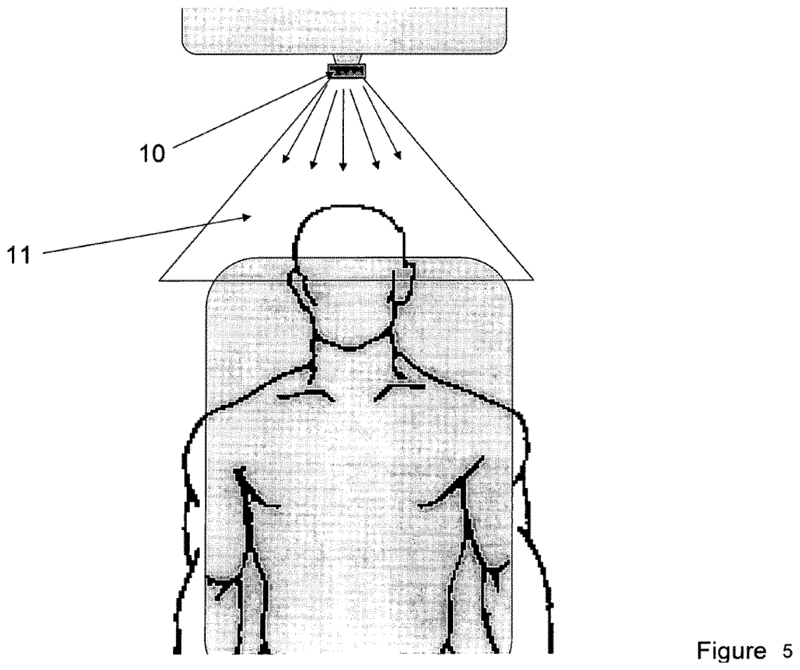

FIG. 4 illustrates the use of an attachment 10 to an external pressure source, in this case the fan on an airplane, in order to generate the pressure differential required for positive pressure isolation. FIG. 5 illustrates the same embodiment, but with the use of a canopy to further isolate the user from their surroundings. Any of the embodiments disclosed herein may be connected to a plane or vehicle fan source to facilitate its function. The air source may be the ventilation system in a plane, car, truck, etc.

FIG. 6 illustrates an embodiment capable of providing air filtration and/or evaporative cooling and/or protection from the external environment. In this embodiment, designed to protect the user from various hazards in their environment, the fan/filter 13 may also generate evaporated water in order to allow for cooling of the user. Furthermore, additional garments or outwear may also be used to protect the user from their external environment here illustrated as a mantle 12 over the users shoulders. In the illustrated embodiment, the user would be protected from all the hazards of the outdoor working environment, including exposure to toxins/pathogens in the air and/or exposure to excessive heat and/or exposure to harmful radiation.

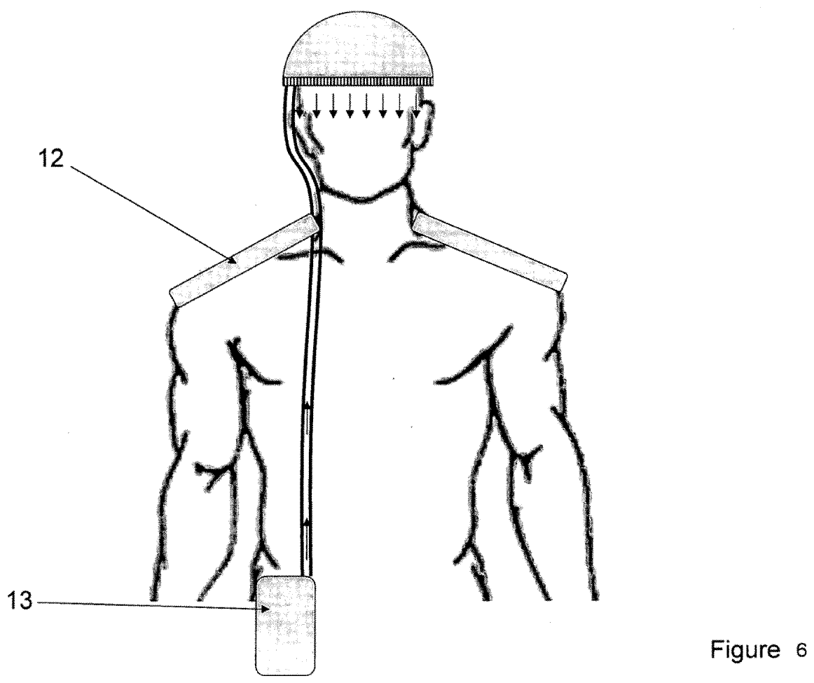

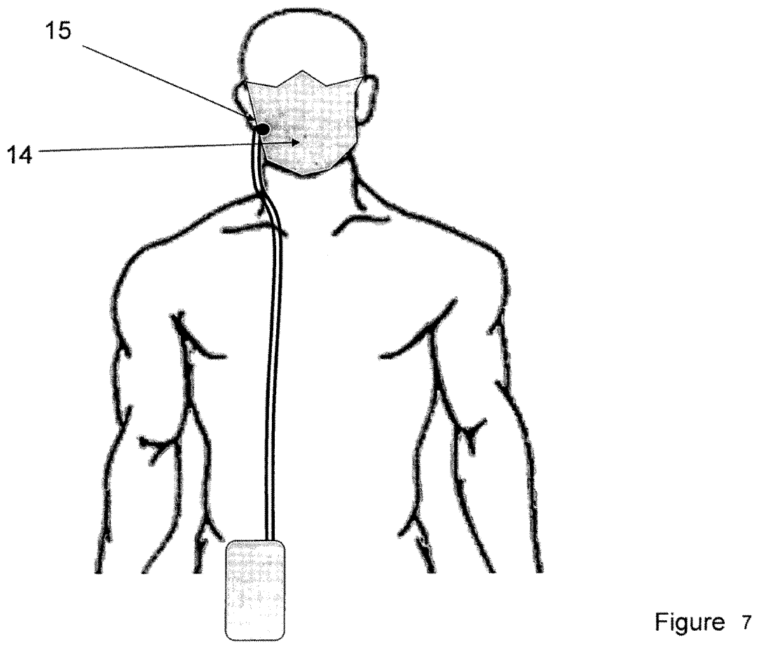

FIG. 7 illustrates an embodiment designed for use with a standard or customized face mask 14. Air flow may be to the face mask (to isolate the user from his/her surroundings) or from the face mask (to prevent transmission of pathogens from the user). In this embodiment, the face mask may form a seal around the user's nose and mouth or may allow air to enter or leave the region of the nose and/or mouth via the edges of the mask. This embodiment may generate positive pressure under the mask (thus isolating the user from the environment) or a negative pressure (thus isolating the environment from the user). This design is ideal for healthcare workers and other users that desire improved efficacy compare to a standard face mask. This embodiment may be used with standard face masks, may be manufactured as a single unit with the face mask attached or may require a face mask with an optional ventilation/air flow port 15. Anticipated, but not illustrated, is an optional air bladder which may be placed anywhere in line with the air flow path. For example, the bladder may be in the ventilation tubing, or in the controller, near the filter or fan. This bladder will allow a full, natural inhalation of filtered air without the need for excessive air flow during exhalation. This bladder, used in combination with a face mask and positive pressure maintenance between the face and the mask, will provide for a much more effective isolation. This bladder may be used with any of the embodiments and may be synchronized to inflate or deflate with the user's natural breathing. The bladder may also be used in embodiments which do not include a positive pressure source, or for periods of time without a positive pressure source.

FIG. 8 shows an embodiment of the isolation system which has been incorporated into either functional headphones, or a device which resembles headphones. Top portion 802 is shown here connecting two ear pieces 804. Some embodiments may include only one ear piece. Also shown is air line/extender 806 which connects the top portion and/or ear piece to air vent 808. The purpose of extender 806 is to bring the air vent closer to the mouth and the nose of the user. However, some embodiments may not include the extender and the air vents may be incorporated into the ear pieces, top piece or other piece of the headphones. Extender 806 and vent 808 may resemble a headphone microphone. Extender 806 and vent 808 may function as a headphone microphone.

The air source/filter for this embodiment may be remote, as is represented by controller 812, or may be incorporated into the headphones. If remote, the controller may be connected to the headphones via air tubing 810. Controller 812 may include the air source, filter, controls of the device, display, electronics, battery or other power source etc. in some embodiments, all the functions of the controller are in one location, such as in remote controller 812, or in the headphones. In some embodiments, the functions of the controller are in different locations. For example, the controls and display may be on a mobile phone or other device, while the fan and filter may be on the controller 812. Communication between components of a controller may be wired or wireless.

FIG. 9 shows an embodiment of the headphone isolation device where air source/filter 908 is controlled by mobile phone 902 via Bluetooth connection 904 to create air flow/pressure 906 from the air vent.

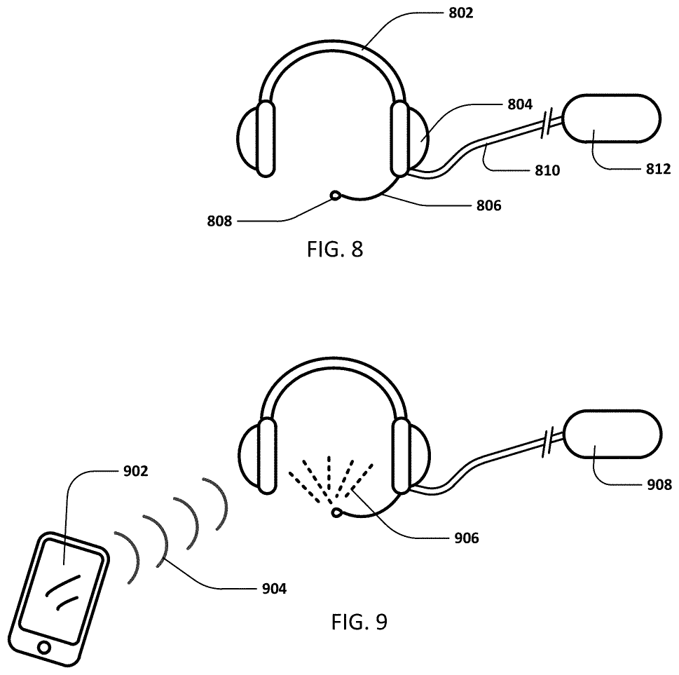

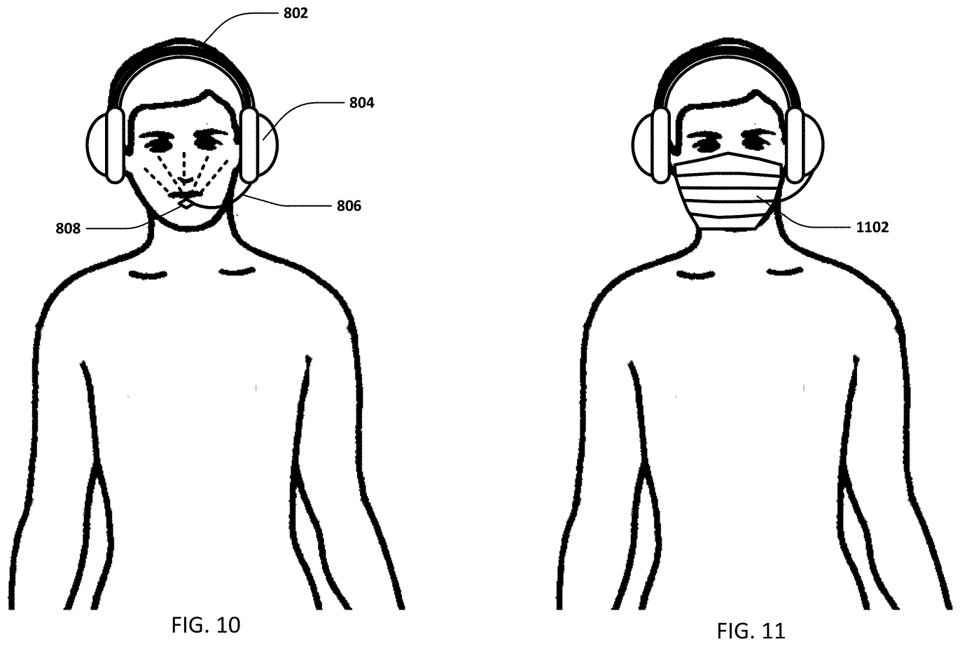

FIG. 10 shows an embodiment of the isolation device in use on a user. Note that the air vent is placed near the user's nose and mouth to create a positive pressure environment in that area. The extender is adjustable so that the vent can be placed in the correct place for any user. The extender may be adjusted up down, toward the user, to the left, to the right, away from the user and rotated as well.

FIG. 11 shows an embodiment of the isolation device used with the addition of face mask 1102. In this configuration, the vent is placed underneath the mask so that it is venting air under the mask. The mask may be an off the shelf mask, such as a paper or Tyvek mask, or may be a proprietary mask. A proprietary mask may have a notch, hole or other orifice for the extender and vent. The mask may seal to the face of the user or may leave a gap or gaps between the face of the user and the mask.

In any of the embodiments disclosed herein, one or two or more vents may be present, and one or two or more extenders may be present.

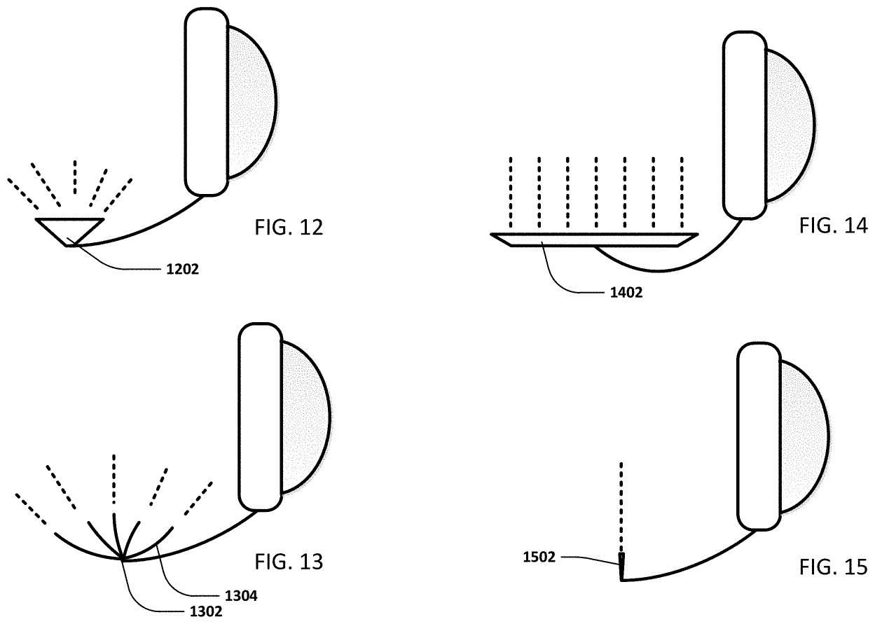

FIG. 12 shows an embodiment of the vent. Vent 1202 has a conical shape which disperses the air flow as it escapes the vent.

FIG. 13 shows an embodiment of the vent. Vent 1302 has several arms 1304 to distribute the air flow as it escapes the vent. The arms may be pliable and may be anywhere from 1 mm to 4 or 5 cm long.

FIG. 14 shows an embodiment of the vent. Vent 1402 includes several openings along its length. Vent 1402 may be flexible, and/or may be curved. The length of vent 1402 may be from about 2 cm to about 20 cm.

FIG. 15 shows an embodiment of the vent. The vent shown here comprises nozzle 1502 which may offer a higher pressure which can be aimed at different parts of the face. Any of the embodiments disclosed herein may be used with or without a mask.

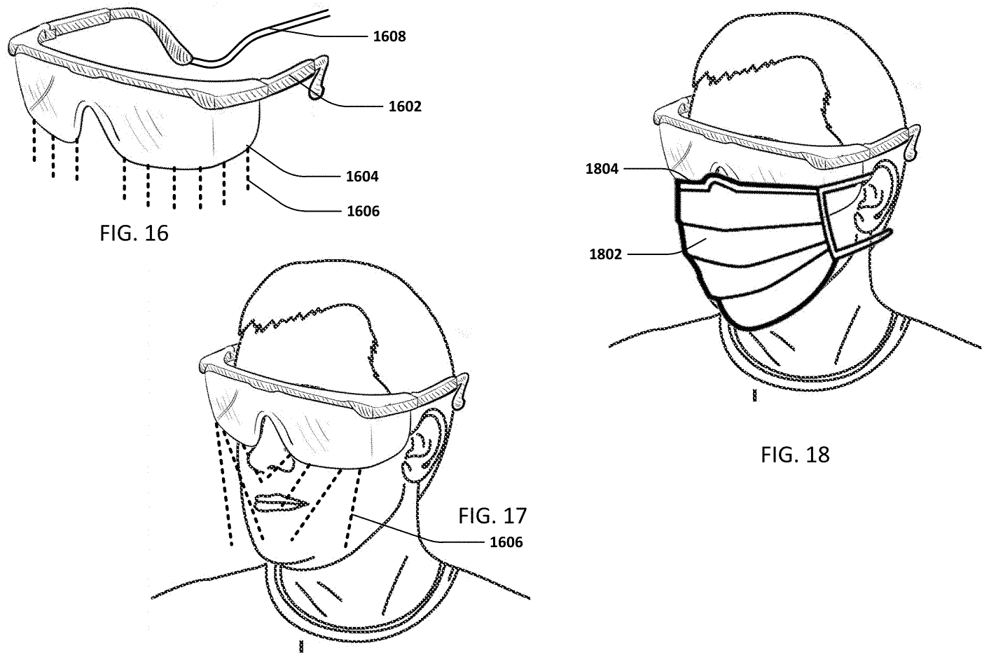

FIG. 16 shows an embodiment of the isolation device which has been incorporated into eyewear, such as glasses or goggles. The eyewear may seal to the face, not seal to the face, or partially seal to the face. For example, the top portion of the eyewear may seal to the face, while the bottom portion of the eyewear leaves a space between it and the face. Shown here are temple portions 1602, air vents 1604, vented air 1606 and air source tubing 1608. This figure shows the air vents at the bottom of the lens, however, the vents may be along a bottom rim, in the temple portions, in the top rim, from one or more extension pieces placed anywhere on the eyewear, and/or elsewhere.

FIG. 17 shows the isolation device of FIG. 16 in use.

FIG. 18 shows the isolation device of FIG. 16 in sue in conjunction with face mask 1802. The mask may be placed near, or over, the bottom of the eyewear. The eyewear, and/or the mask may include seal 1804 to aid in sealing the mask to the eyewear. The mask may be specifically designed to work with the eyewear or may be an off the shelf mask. The mask may be incorporated into the eyewear. For example, the mask may reside inside the lower rim of the eyewear, and may be pulled down when needed to cover the nose and/or mouth.

FIG. 19 shows an embodiment of the isolation device incorporated into a travel pillow. Other types of pillows could also be used. Pillow 1902 is shaped to curve around the neck so that at least a portion of the pillow is in front of the neck of the user when in use. Air vents 1904 may reside along the front inner portion of the pillow as shown here, or may be on the top of the front and/or side sections of the pillow. The vents may be incorporated into a flexible strip which can be connected to the pillow to position the vents however is needed. The strip may be connected to the pillow by Velcro or other attachment means. Alternatively the vents may be built into the pillow. The vents may be directed by inflating a separate portion of the pillow, such as a separate reservoir along the front top of the pillow which changes the angle of the vents as inflated. As with other embodiments, the filter/fan/air source may be incorporated into the pillow or may be separate, and connected by tubing.

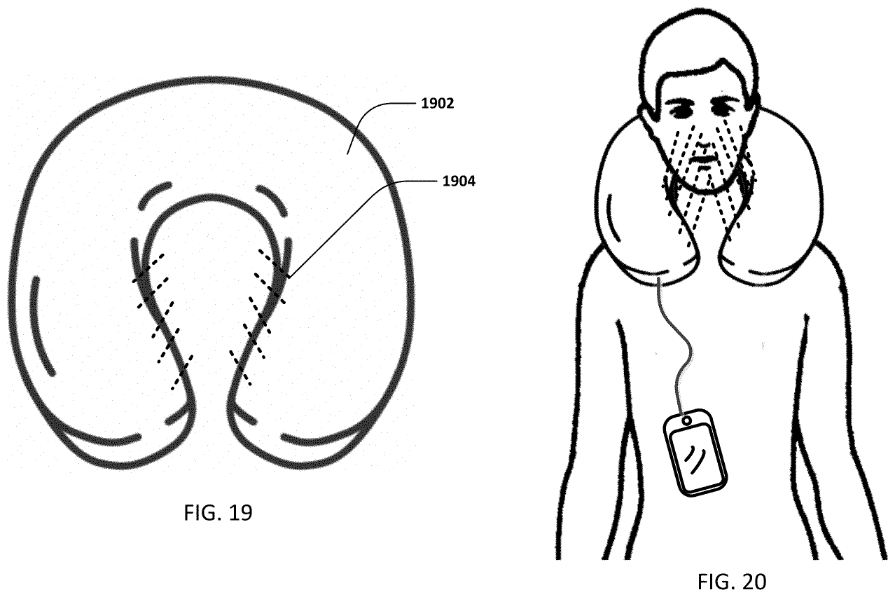

FIG. 20 shows the embodiment of FIG. 19 in use, and controlled by a mobile phone which is wired to the pillow.

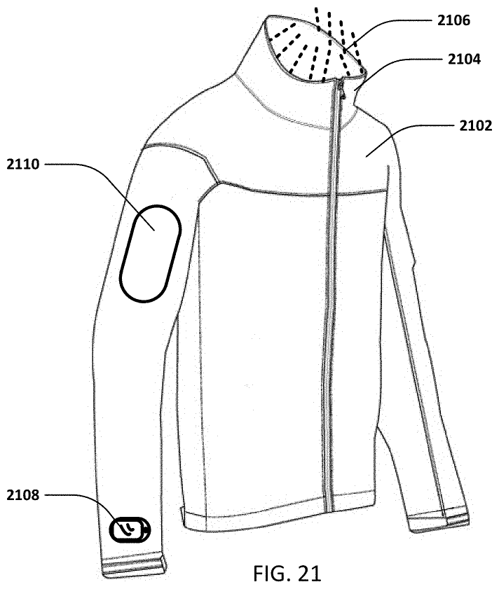

FIG. 21 shows an embodiment of the isolation device which is incorporated into, or can be added to, the collar of a garment, such as a jacket or shirt. Air vents 2106 may be incorporated into a fabric strip which may be built into collar 2104 of garment 2102 or may be added to the garment via an attachment mechanism such as Velcro. The controls and/or the air source/filter for the device may be incorporated into the garment as well. For example, air source/filter 2110 may be incorporated into the upper arm of the garment and controls/display 2108 may be incorporated into the lower arm of the garment. Other locations are also envisioned. The tubing for air transport between the air source/filter and the vents may run along the inside of the garment, the outside of the garment or elsewhere.

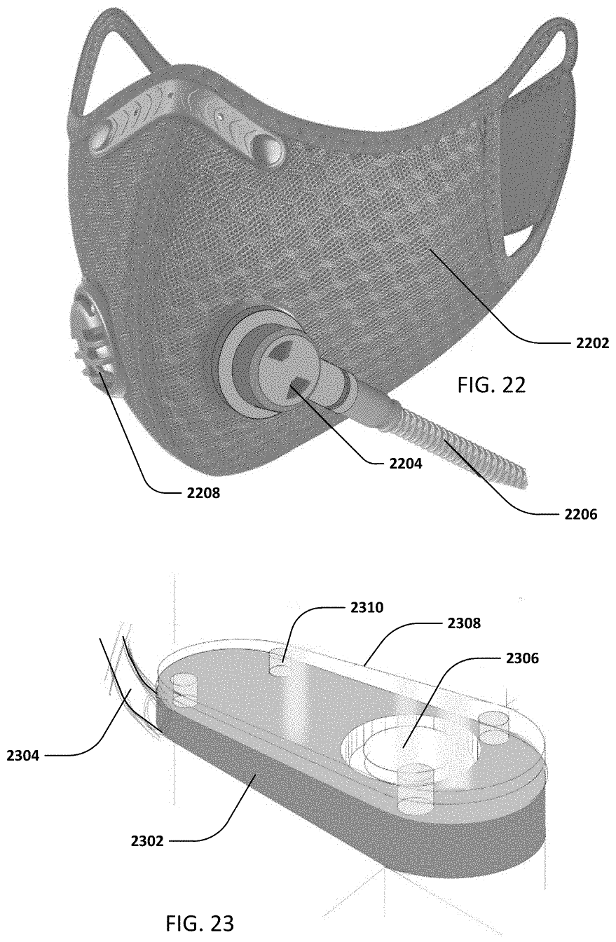

FIG. 22 shows an embodiment of the isolation device which is incorporated into a mask. Mask 2202 shown here includes air inlet port 2204, connected to air supply tubing 2206 and air outlet port 2208. Either or both the inlet port and the outlet port may include a one-way valve. For example, a one-way valve at inlet port 2204 will allow fresh air to enter the mask via the inlet port, but will not allow exhaled air to exit via the inlet port. Similarly a one-way valve at outlet port 2208 would allow exhaled air to exit the mask (as well as any excessive incoming air from inlet port 2204), but will not allow the user to breath in outside air through the exit port. The mask shown here may seal tightly against the face or may leave some gap between the mask and the face. Tubing 2206 may be corrugated to allow for hoop strength and flexibility.

FIG. 23 shows an embodiment of the air source/filter. Shown here is air source/filter 2302, air supply inlet port 2306, and sneeze guard 2308 which is separated from the air supply inlet port by spacers 2310. Also shown is air supply tubing 2304. Sneeze guard 2308 protects the air supply inlet port from contamination from the surrounding environment, while allowing free flow of air into the port. Inlet port may also be protected by one or more filters.

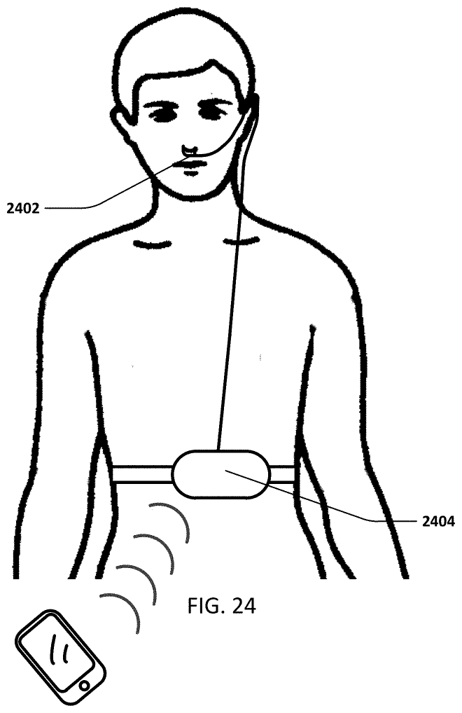

FIG. 24 shows an embodiment of the isolation device which is designed for the nostrils. The air supply tube may wrap over one or both ears, and air vent 2402 may include one or two extensions to be placed in the nostrils. Air source/filter 2404 is shown here on a waist strap and is controlled wirelessly by a mobile phone.

Some embodiments of the isolation device have a surge mode. A surge mode may be invoked in the presence of a sneeze or other sudden contamination of the environment. A surge mode may be invoked manually, by pushing or holding a button on the controller, or may be invoked automatically, by the controller sensing a sneeze via a microphone or pressure sensor or other sensor. The controller may “learn”, by using a microphone to record ambient noise. The user may push the surge mode button when a sneeze has occurred in the user's area. The controller may use controller logic to associate the noise recorded immediately before the surge button was pressed and associate the noise with a hazardous situation. Over time, the controller may automatically initiate surge mode based on hearing similar noises.

Some embodiments of the isolation device may include solar charging panels to charge a battery to power the device.

Some embodiments of the isolation device may include batteries which can be charged wirelessly. Some embodiments of the isolation device may include the ability to recharge mechanically, similar to watches which wind themselves based on kinetic motion. Some embodiments of the isolation device may include a recharging docking station for recharging when not in use.

Some embodiments of the isolation device may include sensors which sense contaminates in the environment. Sensors may also sense oxygen level or other gas levels.

Some embodiments of the isolation device may include a display which may show the user power level, battery remaining, alarms and alerts when sensor sense a change in the environment, etc.

Some embodiments of the isolation device may include the ability to supply a gas other than air, such as oxygen. Some embodiments of the isolation device may include the ability to heat or cool the incoming air or gas.

Some embodiments of the isolation device may include a UV light, a filter or other decontamination technologies to decontaminate the incoming or outgoing air. A UV light may be near the filter, in the inhalation or exhalation tubing, at the inlet or outlet or near or at the vent of the device. Other decontaminating technologies may include ionization, etc.

Some embodiments of the isolation device may include an air reservoir, such as tank, bag or balloon. The reservoir of air may be used for short periods of time when the battery dies, or when an urgent contamination threat is present, such as a sneeze. The reservoir may be refilled when the battery is recharged or the urgent contamination threat has passed. The reservoir may be anywhere in the system.

Some embodiments of the isolation device may include a Herschel-Quincke type mechanism to power the air source.

Some embodiments of the isolation device may include an accelerometer which senses activity. The air supply may be minimized when activity is low (such as when the user is sleeping or sitting for periods of time) and increased as activity is increased (i.e. medium air supply for walking, more for running). The isolation device may also be integration with activity tracking devices such as a Fitbit for the same purpose. The isolation device may also have a microphone, pressure sensor, flow sensor or other sensors which detect breathing of the user. Air flow can be adjusted up and down for fast and slow breathing, in addition to being adjusted for each breath—i.e. low air supply flow during exhalation and higher air supply flow during inhalation.

In some embodiments, a pressure sensor may be in the controller, and may measure the pressure at the filter (the “inside” of the filter) and compare it to atmospheric pressure. In some embodiments a pressure sensor may be in the controller between the fan and the filter. In some embodiments, a pressure sensor may be within the mask itself, or in the tubings.

Some embodiments of the isolation device may include or incorporate with a standard CPAP mask.

Some embodiments of the isolation device may be incorporated into earmuffs, a hat, mask or other items which are normally worn.

Some embodiments of the isolation device may be portable. Some embodiments of the isolation device may be tied to a larger system such as a power outlet or an air pressure or filter source.

Some embodiments of the isolation device may filter viruses to prevent virus transmission. For example, the filter of the isolation device may filter particles down to around 0.02-0.3 μm. In some embodiments the filter may filter particles down to around 0.02 μm. In some embodiments the filter may filter particles down to around 0.1 μm. In some embodiments the filter may filter particles down to around 0.5 μm. In some embodiments the filter may filter particles down to around 1.0 μm. In some embodiments the filter may filter particles down to around 2.0 μm. In some embodiments the filter may filter particles down to around 5.0 μm.

In some embodiments of the isolation device, the air supply flow rate may range from around 5-8 L/min.

In some embodiments of the isolation device, the battery may have a capacity of around 6000 mAh. In some embodiments of the isolation device the battery lasts around 6-9 hours. In some embodiments of the isolation device, the fan may be around 97×94×33 mm

In some embodiments of the isolation device the filter is replaceable. In some embodiments of the isolation device the filter is able to be cleaned.

In some embodiments of the isolation device the ID of the air supply tubing is greater than around 7.5 mm. In some embodiments of the isolation device, the air supply tubing is kink resistant, and may have reinforcements in the wall of the tubing. In some embodiments of the isolation device the air supply tubing may be attached and detached from both the air supply/filter and the mask/eyewear or other air delivery device.

In some embodiments of the isolation device the air is moved through the device via a vacuum source rather than a pressurized air source or positive pressure fan.

In some embodiments of the isolation device a pressure differential is created using sound waves.

Some embodiments of the isolation device include a mechanism to reduce moisture around the face.

In some embodiments of the isolation device, the mask, a portion of the mask, or all or a portion of the device may be printed on a 3D printer for a custom fit to the face or other body part of the user.

In some embodiments of the isolation device, a hydrophobic coating is incorporated into a mask and/or eyewear and/or other component of the device.

### Example of Data Processing System

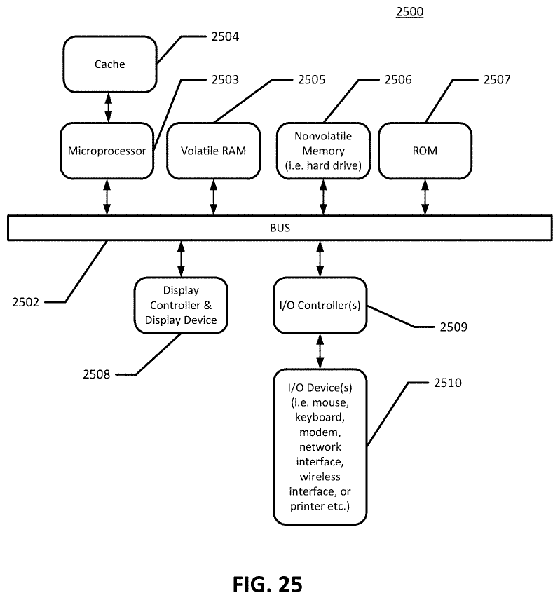

FIG. 25 is a block diagram of a data processing system, which may be used with any embodiment of the invention. For example, the system 2500 may be used as part of a controller, server, mobile device, hand piece, computer, tablet, etc. Note that while FIG. 25 illustrates various components of a computer system, it is not intended to represent any particular architecture or manner of interconnecting the components; as such details are not germane to the present invention. It will also be appreciated that network computers, handheld computers, mobile devices, tablets, cell phones and other data processing systems which have fewer components or perhaps more components may also be used with the present invention.

As shown in FIG. 25, the computer system 2500, which is a form of a data processing system, includes a bus or interconnect 2502 which is coupled to one or more microprocessors 2503 and a ROM 2507, a volatile RAM 2505, and a non-volatile memory 2506. The microprocessor 2503 is coupled to cache memory 2504. The bus 2502 interconnects these various components together and also interconnects these components 2503, 2507, 2505, and 2506 to a display controller and display device 2508, as well as to input/output (I/O) devices 2510, which may be mice, keyboards, modems, network interfaces, printers, and other devices which are well-known in the art.

Typically, the input/output devices 2510 are coupled to the system through input/output controllers 2509. The volatile RAM 2505 is typically implemented as dynamic RAM (DRAM) which requires power continuously in order to refresh or maintain the data in the memory. The non-volatile memory 2506 is typically a magnetic hard drive, a magnetic optical drive, an optical drive, or a DVD RAM or other type of memory system which maintains data even after power is removed from the system. Typically, the non-volatile memory will also be a random access memory, although this is not required.

While FIG. 25 shows that the non-volatile memory is a local device coupled directly to the rest of the components in the data processing system, the present invention may utilize a non-volatile memory which is remote from the system; such as, a network storage device which is coupled to the data processing system through a network interface such as a modem or Ethernet interface. The bus 2502 may include one or more buses connected to each other through various bridges, controllers, and/or adapters, as is well-known in the art. In one embodiment, the I/O controller 2509 includes a USB (Universal Serial Bus) adapter for controlling USB peripherals. Alternatively, I/O controller 2509 may include an IEEE-1394 adapter, also known as FireWire adapter, for controlling FireWire devices.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques shown in the FIGS. can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the FIGS. herein may be performed by processing logic that comprises hardware (e.g. circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

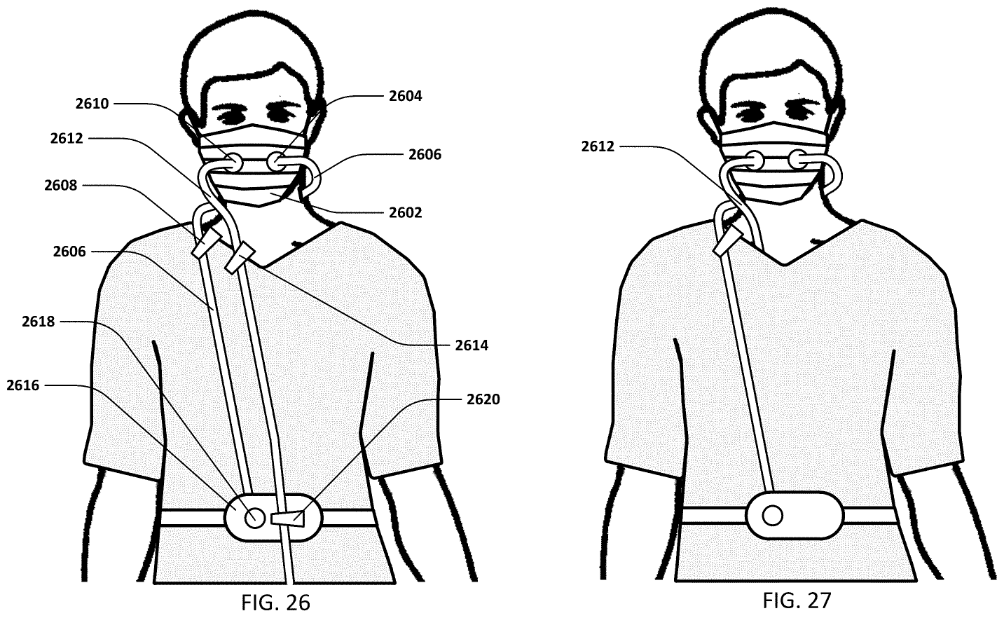

FIG. 26 shows an embodiment of the isolation device which includes both inhalation and exhalation ports as part of a mask. In this embodiment the mask would generally have a seal around the face. Mask 2602 includes inhalation port 2604 connected to inhalation tubing 2606, and exhalation port 2610 connected to exhalation tubing 2612. Inhalation tubing 2606 may be held to clothing by clip 2608. Exhalation tubing 2612 may be held to clothing by clip 2614. Controller 2616 may be strapped to the user via straps and may also include tubing clip 2620. In this embodiment, the controller also includes inhalation filter 2618.

In this embodiment, mask 2602 may seal tightly to the face, so that a significant amount of air does not enter or escape the mask between the mask and the face. Substantially all of the inhaled air enters the mask via inhalation port 2604 and substantially all of the exhaled air exits the mask via exhalation port 2610. The inhalation line may include a one-way valve, allowing air to enter the mask but not exit the mask, at the inhalation port, in the inhalation tubing, or at the controller. The inhalation line may include a filter at the inhalation port, in the inhalation tubing, or at the controller, as shown here.

The exhalation line may include a one-way valve, allowing air to exit the mask, but not enter the mask, at the exhalation port, in the exhalation tubing, or at the controller. The exhalation line may include a filter, but in some embodiments, the exhalation line does not include a filter, allowing for the user to exhale without resistance. In some embodiments the exhalation line may include a course filter, designed to catch droplets, but not necessarily smaller particles, and still allow the user to exhale with minimal resistance.

Filter materials may include, in addition to materials disclosed elsewhere herein, cotton, polypropylene, Nylon, polyester, wool, paper, fiber, felt, or other suitable materials. A “course” filter may be a filter which generally captures droplets but not aerosols, allowing for less inhibited air flow through the material. Course filters may capture particles larger than around 5 μm. In some embodiments, filters may capture particles larger than around 0.5 μm. In some embodiments, filters may capture particles larger than around 1.0 μm. In some embodiments, filters may capture particles larger than around 10.0 μm. In some embodiments, filters may capture particles larger than around 15.0 μm.

In this and other embodiments, the controller may provide positive pressure to the mask, negative pressure to the mask or both. For example, this embodiment may supply slight positive pressure to the mask, but allow resistance free, or very low resistance, escape of air via the exhalation port. The positive pressure air supplied to the mask may be filtered. The exhalation line may not include a filter. This combination would allow the user to protect himself from contaminants in the ambient air, while also protecting those around him from his direct exhalation. The end of the exhalation tubing may be placed on the floor, inside the user's clothing, or in another exhaust location which limits others' exposure to the exhaled droplets.

The exhalation tubing may be placed inside the user's clothing, as shown in FIG. 27. In some embodiments, the exhalation line may include a course filter so that droplet escape is minimized, while still allowing minimal resistance during exhalation. In this embodiment the mask would generally have a seal around the face.

The exhalation line may include the ability to disinfect the exhaled air/droplets, including a UV light, chemical filters, etc. in the port, tubing and/or controller. For example, UV light may be incorporated into a substantial portion of the length of the tube.

In some embodiments, the exhalation filter may terminate into a reservoir, for example, a compliant reservoir, which has a large surface area. The reservoir may serve as a buffer, filling when the user is breathing hard, and emptying, when the user is breathing less hard. The reservoir may be fully or partially constructed from a filter material, such as a course filter material.

FIG. 28 shows an embodiment of the isolation device which provides both pressurized air, through the inhalation tubing, and negative pressure, via the exhalation tubing. In this embodiment the mask would generally have a seal around the face. The controller controls both the positive pressure and the negative pressure. Inhalation filter 2618 and exhalation filter 2802 may exist in the controller, as shown here, at the end of the inhalation tubing and exhalation tubing respectively, or they may exist elsewhere in the system. The inhalation filter protects the user, and the exhalation filter protects those in proximity to the user.

These filters, and all the filters in embodiments disclosed herein, may be removed and replaced. Different types of filters may be used. For example, filters may be used specifically to block particulate, smoke, viruses, bacteria, small particles, droplets, chemicals, toxins, gases, VOCs, etc. A different filter may be used for the exhalation and the inhalation. For example, in the case of a fire, a smoke and particle filter may be used in the inhalation line, while no, or substantially no filter may be used on the exhalation line. In the case of a pandemic, a virus filter may be used on the inhalation line, and a virus filter, or a droplet filter may be used on the exhalation line. Some embodiments have an exhalation filter, but not an inhalation filter, and some embodiments have an inhalation filter and not an exhalation filter.

In some embodiments, the positive pressure and negative pressure may both be controlled within a single tubing, alternating the positive and negative pressure.

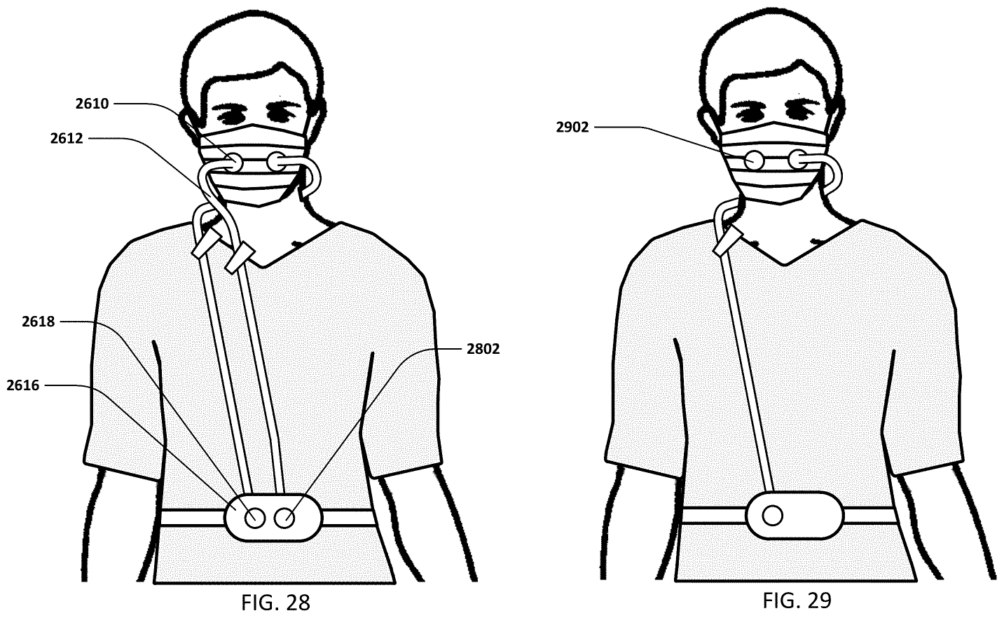

FIG. 29 shows an embodiment of the isolation device with a positive pressure line and no exhalation line. Exhalation port 2902 is shown, and may include a filter, a one-way valve or both. The filter may be a course filter design to block droplets, or may be a finer filter. In this embodiment the mask would generally have a seal around the face.

In embodiments with both positive and negative pressure, the positive pressure and negative pressure may be controlled to correlate with the user's breathing, to minimize the chances of inhalation and/or exhalation leaking between the mask and the user's face and to minimize variances from normal breathing pressures. The isolation device may include pressure sensors anywhere in the system to monitor the fluctuating breathing pressure and provide the right amount of positive pressure or negative pressure to maintain as close as possible atmospheric pressures within the mask.

In embodiments with both positive and negative pressure, the positive pressure and negative pressure may alternate, or both operate at the same time. For example, the positive pressure and negative pressure may both operate at the same time, and are adjusted by the controller during breathing to create a stable, approximately atmospheric pressure environment for the user.

Some embodiments of the isolation device may aim to achieve a slightly positive pressure within the mask with respect to atmospheric pressure. Some embodiments of the isolation device may aim to achieve a slightly negative pressure within the mask with respect to atmospheric pressure.

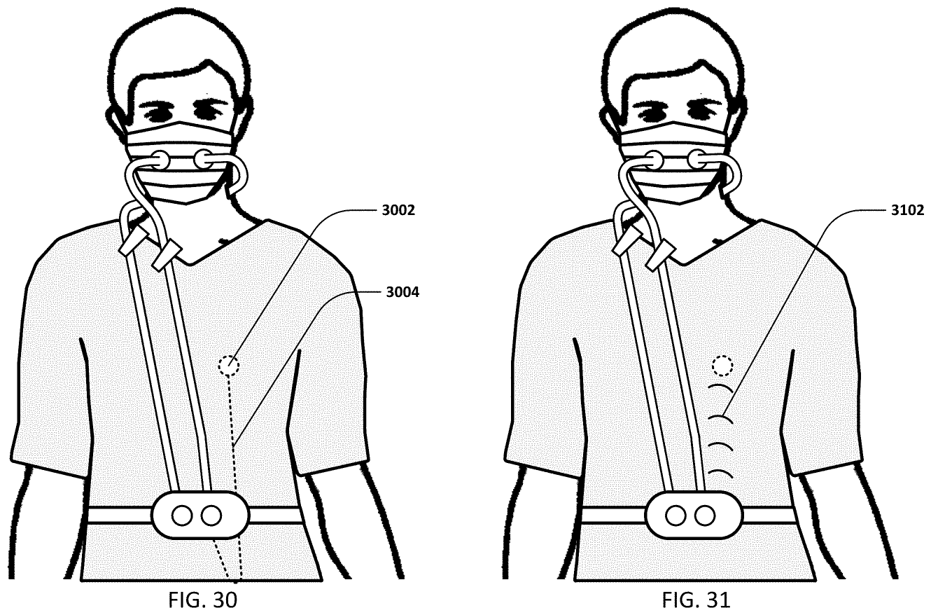

FIGS. 30 and 31 show embodiments of the isolation device which include a sensor on the chest, to monitor breathing. This sensed data may be used to control the positive pressure and negative pressure delivered to the mask to control the pressure within the mask curing breathing. Chest sensor 3002 may be connected to the controller via electrical lead 3004. The chest sensor may sense motion, force, electrical activity, temperature, muscular activity etc. The chest sensor may include an accelerometer, electrodes, a pressure sensor, an ECG sensor, a temperature sensor and/or any other sensor. The chest sensor may alternatively communicate with the controller via wireless communication 3102. A chest, or other sensor may also monitor activity level, such as heart rate, to adjust the pressure fluctuations within the mask to accommodate breathing.

Some embodiments of the isolation device may include a silicone, or other soft, pliable material, seal around the mask where the mask is in contact with the face, to help seal the mask against the face.

Some embodiments of the isolation device may include positive and/or negative pressure without a mask which seals to the face. These embodiments may include enough air flow across the face so that both exhalation and inhalation leaking are minimized.

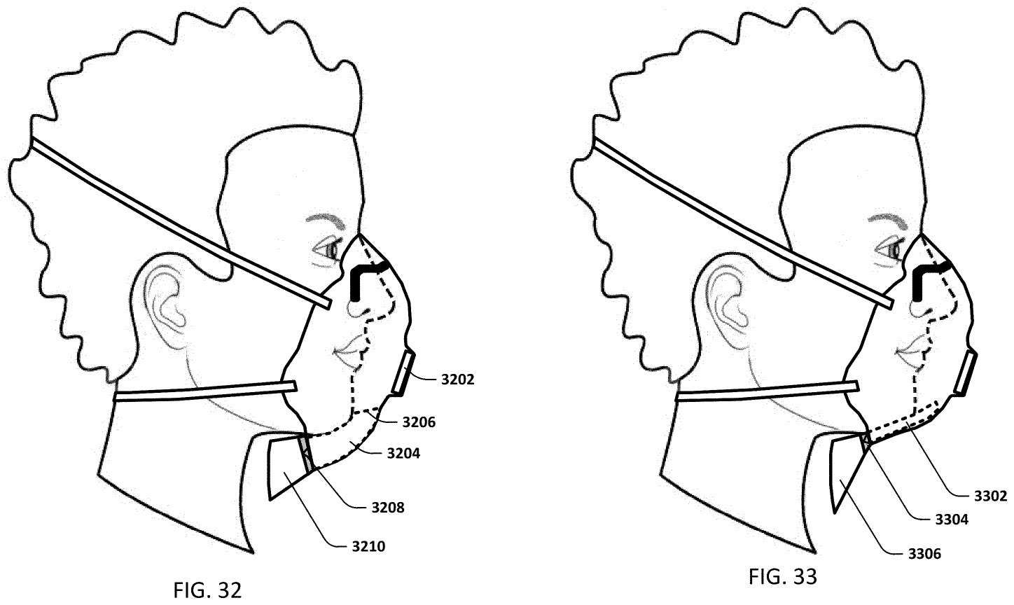

FIG. 32 shows an embodiment of the isolation system which incorporates the exhalation line into the mask. The mask may include inhalation port/filter 3202 and exhalation component 3204 may include exhalation input opening 3206, exhalation output opening 3210 and one-way valve 3208. The exhalation component may also include a filter. This embodiment may also include positive pressure connected to inhalation port 3202, although it is not shown here. The purpose of the exhalation component is to force the exhalation away from other people in the immediate area. The exhalation output opening may be directed toward the user's neck, or elsewhere. It may be directed down the user's shirt for example. The embodiment shown in FIG. 32 shows an exhalation component built into the mask, so that the mask seals adequately around the user's face.

FIG. 33 shows an embodiment similar to that shown in FIG. 32, except that exhalation component 3302 may be used with any standard mask. Exhalation component 3302 is thin enough that it can be slid between the chin and the mask. It could alternatively be slid between the cheek and the mask. The portion of the exhalation component which is under the mask is preferably rigid, or with a high hoop strength to prevent collapse, to maintain an open airway. The exhalation component may include one-way valve 3304 and may or may not include a filter. The exhalation component may be broad and thin, to allow enough air to escape comfortably. The exhalation component output opening 3306 is shown here directed at the user's neck, but could be directed elsewhere. The output opening may be directable, extendable, etc.

Positive pressure and/or negative pressure may be used with the embodiments in FIGS. 32 and 33.

In some embodiments, the inhalation and exhalation port are the same port. In some embodiments, the material of the mask itself serves as the inhalation filter, the exhalation filter or both. For example, the material of the mask may include regions with more resistance to air flow, and regions with less resistance to air flow. In this way, the inhalation and/or exhalation resistance may aid in directing the airflow in and/or out of the mask. For example, the bottom of the mask may be made of a material which is less resistant to airflow, for example, more porous, than the center of the mask. This may direct the exhalation gases downward, away from others. The shape of the mask may aid in directing air flow as well.

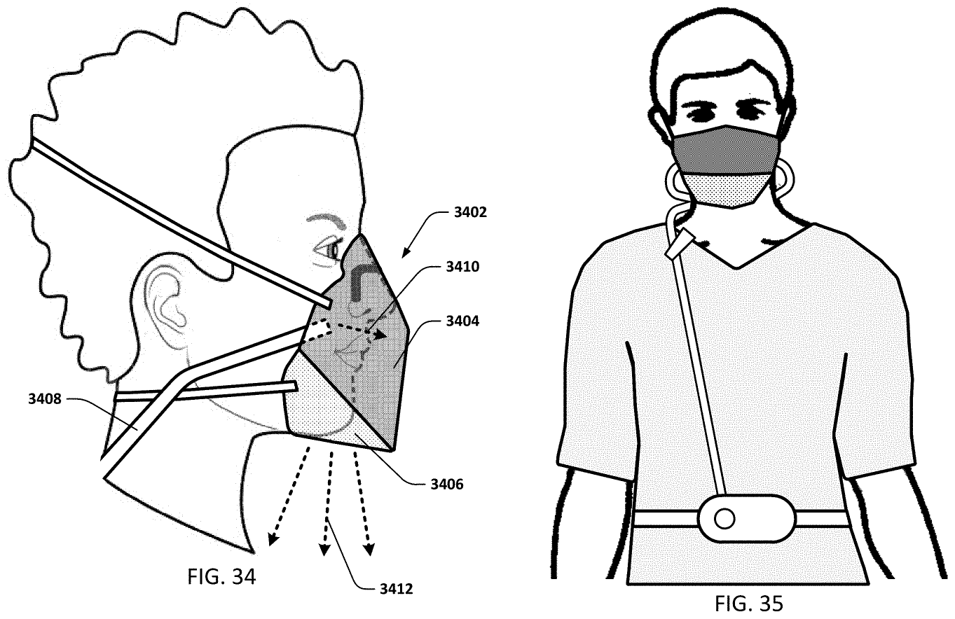

FIG. 34 shows a mask where different portions of the mask have different resistances to air/gas flow. Mask 3402 includes higher gas flow resistant portion 3404 and lower gas flow resistant portion 3406. Filtered air inlet line 3408 introduces filtered air or other gas 3410 into the mask for breathing. One, two or more air inlet lines may be present. The air inlet lines may enter at the side of the mask as shown, or may enter elsewhere. As the person breathes, he/she exhales into the mask. Lower resistance portion 3406 allows the breath to escape through the material of the mask, while higher resistance portion 3404 allows less, or essentially no gas to escape through the material. In this way, the shape of the mask, and the location of the higher and lower resistance materials, can be used to direct exhaled gas 3412 of the user. For example here, the exhaled gas is directed downward, and toward the user. Alternatively or additionally, the exhaled gas may be directed upward, sideward, and/or forward.

As with other embodiments, this embodiment may include a seal between the mask and the face, such as a silicone seal, or a rubber seal, or an adhesive seal. A seal may help direct the exhaled gas through the mask, for better control of the exhalation direction, as well as filtering the exhaled gas via the material of the mask itself, to protect other people in the vicinity.

The differences in resistance of the material of the mask may be achieved by using different materials, materials of different pore size, and/or by adding/subtracting layers of materials at different locations of the mask. For example, the center of the mask may include 2 layers of material, where the lower portion of the mask may be made of a single layer.

Some embodiments may include an added port or portion of the mask which has a lower resistance to gas flow through it. This port may include a filter to prevent contamination of others.

FIG. 35 shows a front view of the embodiment of FIG. 34. The air source/filter is shown strapped to the waists, but it may be worn on the back, shoulders, in a pocket, carried, etc.

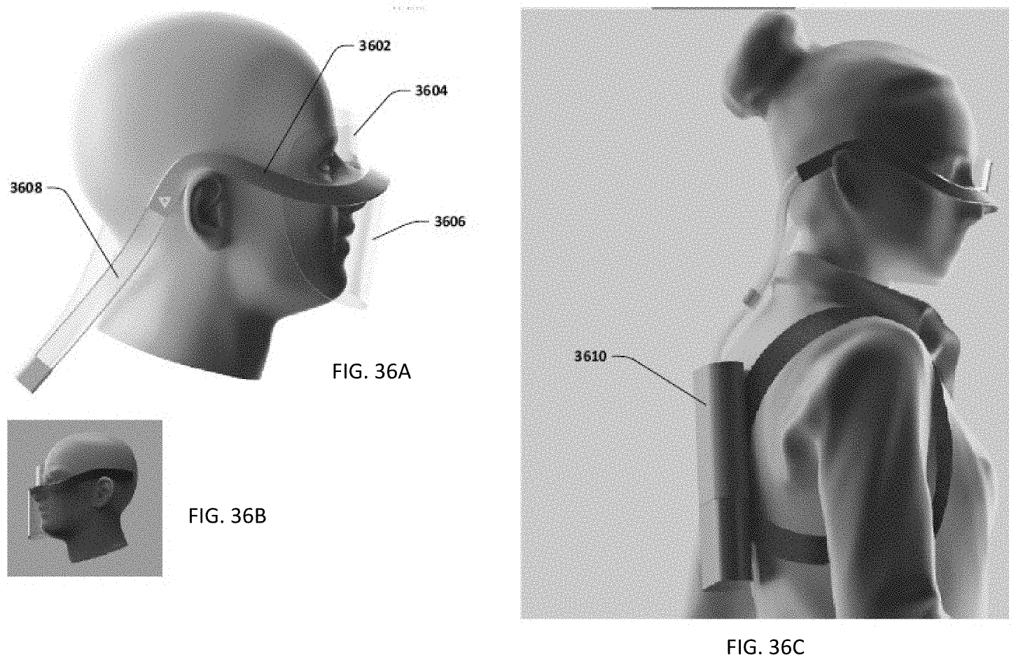

FIGS. 36A-36C show another embodiment of the isolation system. This embodiment is based around a “ribbon” which crosses the face between the eyes and the mouth, preferably above the nose. This embodiment includes the ability to add on eye protection and/or a face shield, or alternatively, the ability to use the system without either the eye protection or the face shield, depending on the needs of the isolation. Shown here are ribbon 3602 which is in fluid communication with supply tube(s) 3608. Also shown is eye protection 3604 and face shield 3606. Controller and/or air supply/filter 3610 is shown supported by strap(s) on the back of the user for portability. Filtered air may exit the device via openings in ribbon 3602. The air may be directed downward to flow over the nose and/or mouth. The openings may be holes, slits or a single elongated slit. The direction of airflow may be designed to be fixed, by the design of the device, or the direction may be alterable by the user, depending on the user's anatomy, preferences, etc.

Supply tube(s) may be flattened for comfort, so wider than they are thick, to lay flat against the user. Ribbon 3602 may similarly be flat in the areas along the side of the face.

This, and any embodiment disclosed herein, may be structured to allow the use of eyeglasses in conjunction with the isolation device.

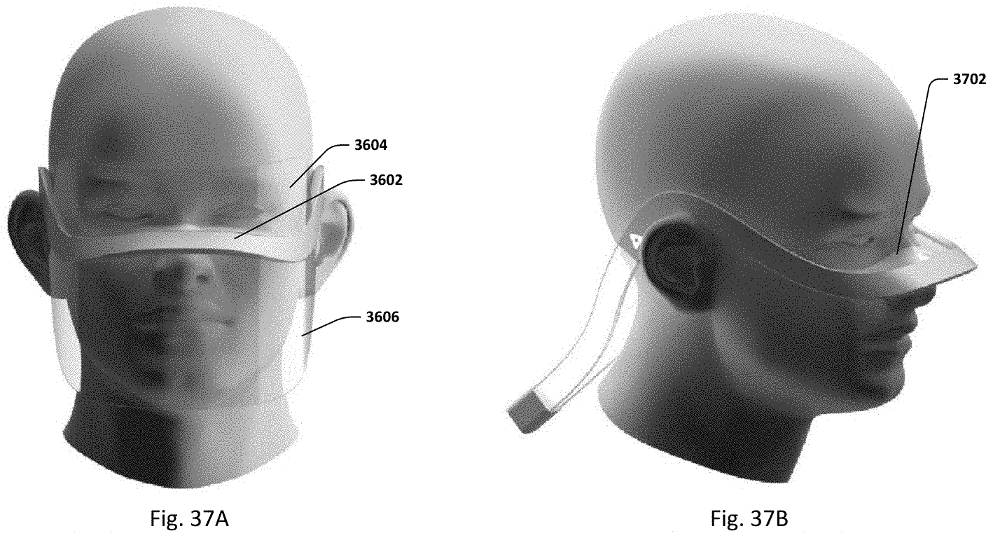

FIGS. 37A and 37B show more views of the embodiment of the isolation system shown in FIG. 36. Also shown is barrier, or skirt 3702 which may exist between ribbon 3602 and the user's face, to seal the device against the face, helping to direct the flow of air downward. This seal may be made from silicone or other appropriate material, allowing skirt 3702, which may be rigid, semi-rigid, or soft, to rest gently on the nose, allowing it to fit a wide range of nose geometries. The embodiment shown in FIG. 37A includes eye shield 3604 and face shield 3606 for more protection than the embodiment shown in FIG. 37B, which does not include either eye nor face shield, and may be appropriate for lighter duty use cases.

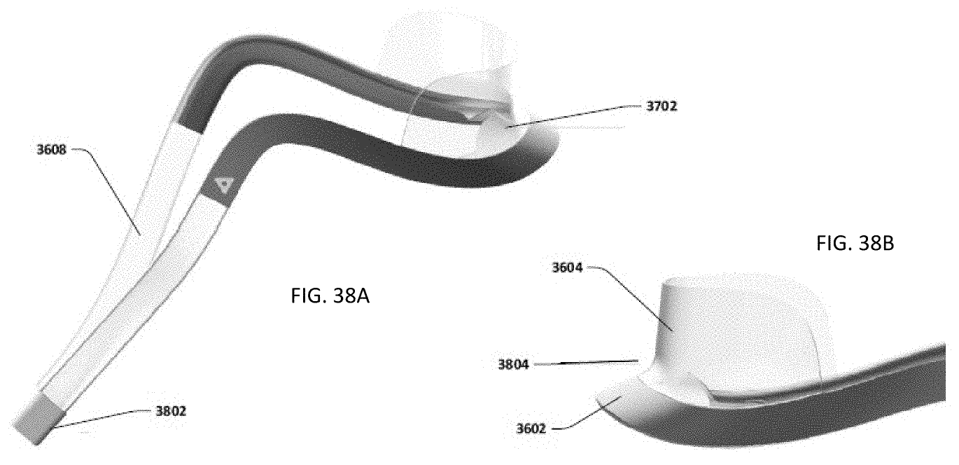

FIGS. 38A and 38B show detailed views of the isolation device shown in FIGS. 36 and 37A and 37B. Also shown here is connector 3802 which physically and fluidly connects supply tube(s) 3608 to a supply hose. This connector may be a quick release connector, such as a magnetic connector, and may connect to a circular hose, flat hose, or hose of any shape. The supply hose may connect so that it is in line with the supply tubes, reducing air resistance. The transition 3804 between eye shield 3604 and ribbon 3602 may have a smoothed radius to create an integrated look.

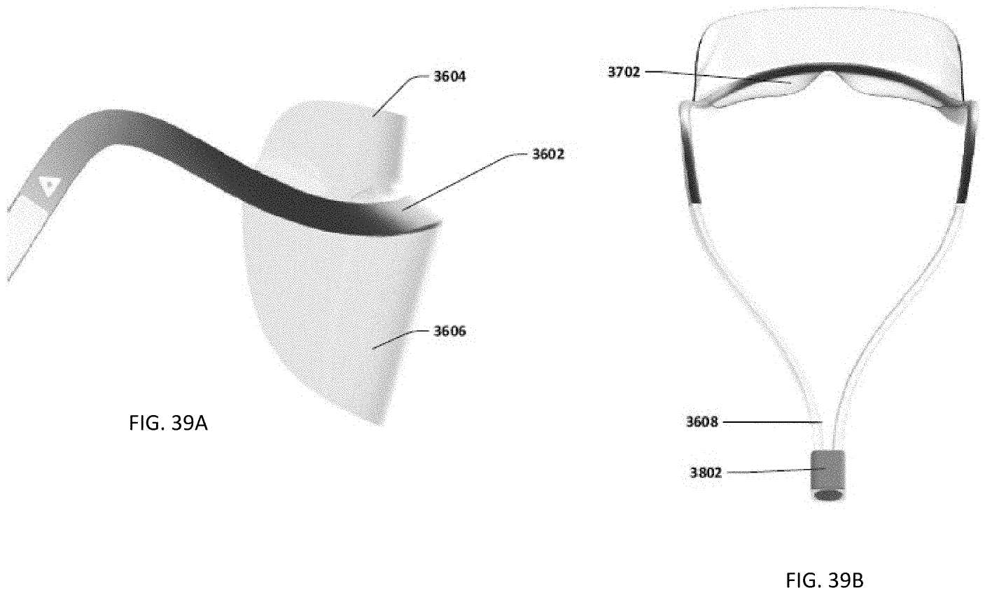

FIGS. 39A and 39B show other views of the isolation device. Note that face shield 3606 may sit further away from the face than eye shield 3604, to accommodate the nose. Supply tubes 3608 may attach to connector 3802 “in line”, or approximately parallel to each other to minimize flow resistance within the tubes.

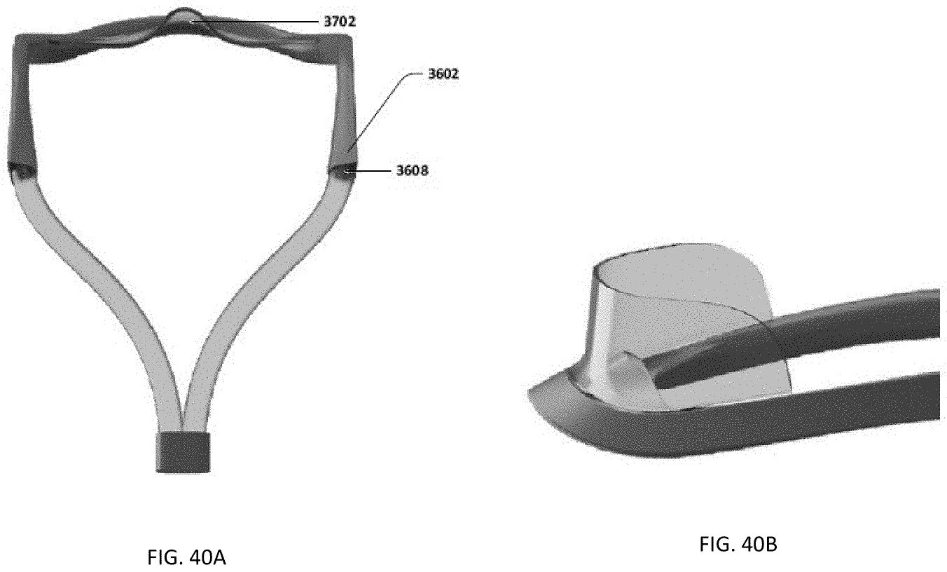

FIGS. 40A and 40B show other views of the isolation device. Shown here are skirt 3702, ribbon 3602, which may be flared at the ends which connect with tubing 3608, to accommodate the tubing.

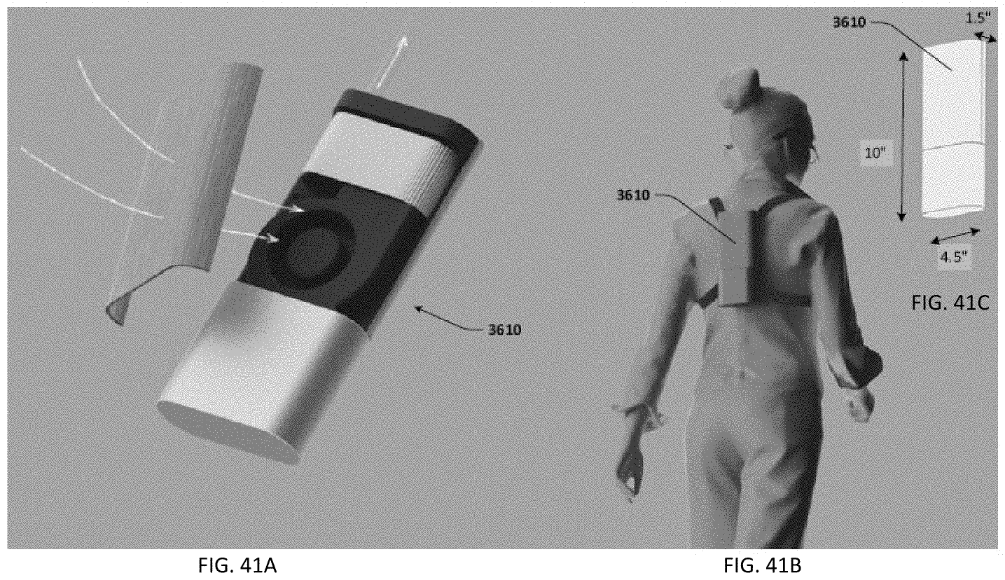

FIGS. 41A-C show more detail around controller and/or air supply/filter 3610. The controller/air supply/filter may include a fabric pre-filter shell which can be detached and machine washed. The HEPA filter and/or fan may be readily accessible for maintenance. The body may be made from aluminum, for lightness and strength, or may be made from any suitable material or combination of materials including polymer, stainless steel, silicone etc.

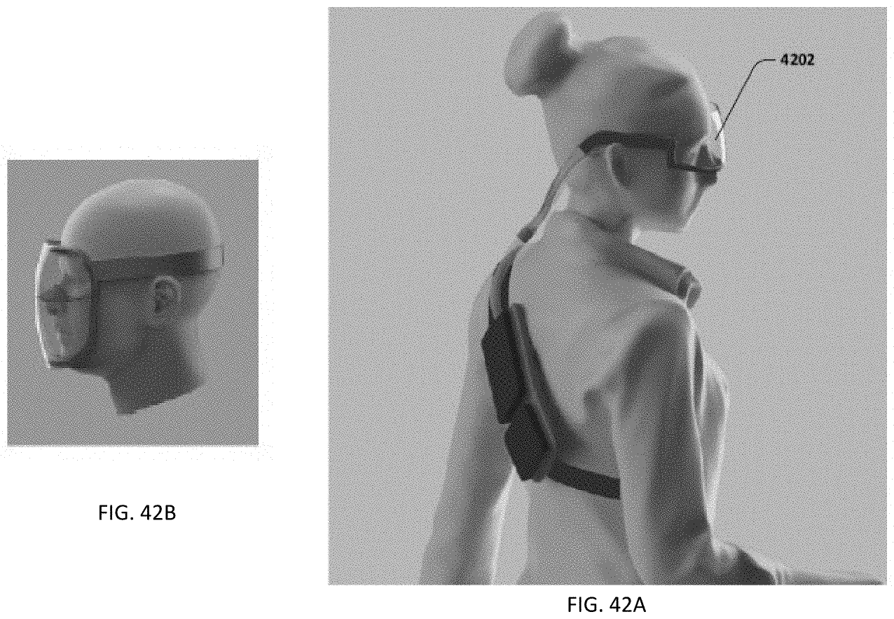

FIGS. 42A and 42B show another embodiment of the isolation system. This embodiment is based around an eye shield. Eye shield 4202 can be worn like glasses, and similar to other embodiments disclosed herein, may be combined with other components, such as a face shield, in a modular fashion.

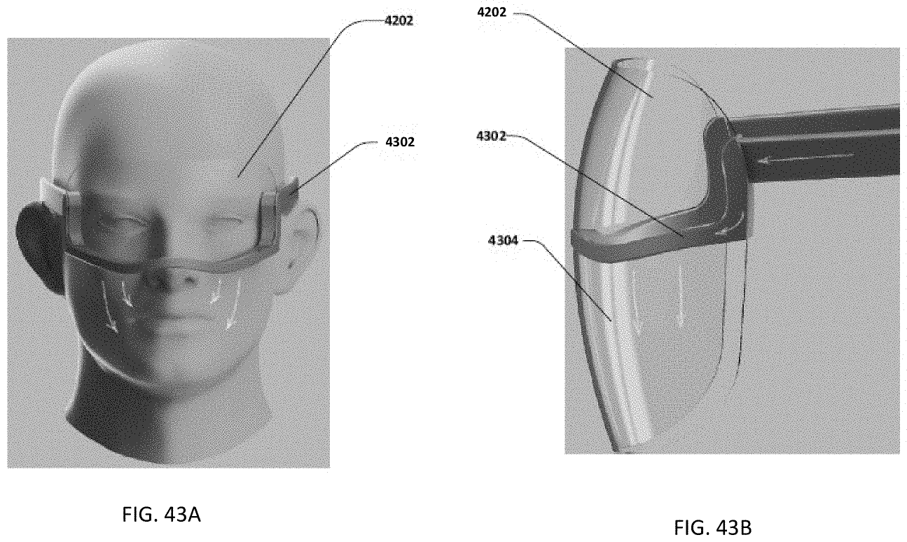

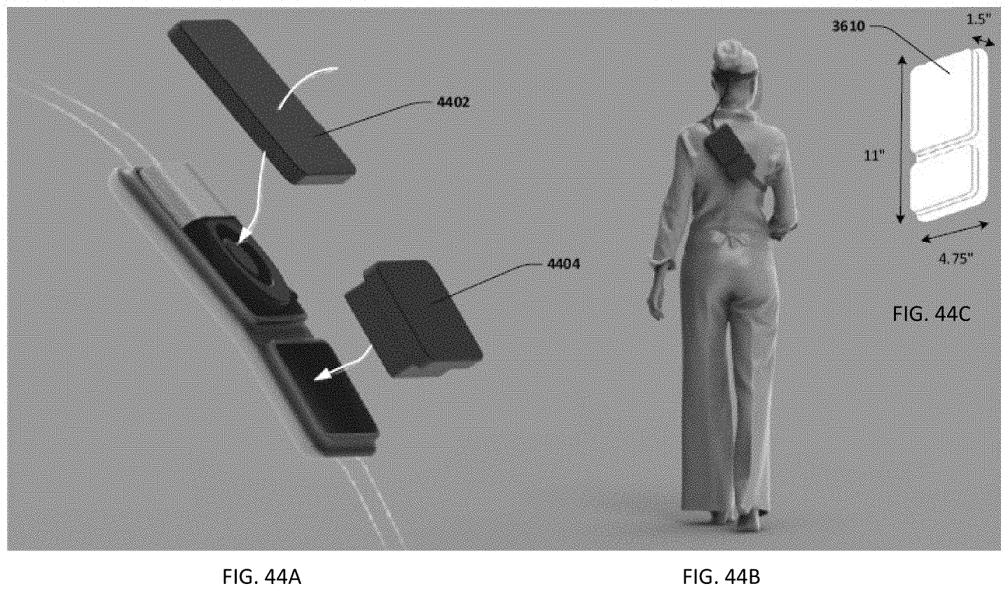

FIGS. 43A and 43B show additional views of the embodiment shown in FIG. 42. Filtered air passes through structure 4302 and downward through openings in structure 4302 and in front of the user's nose and mouth. Air flow in any of the embodiments herein may be laminar and/or turbulent. Face shield 4304 is also shown on the right, attached to structure 4302.

FIG. 44A-C show more detail around controller and/or air supply/filter 3610. Some embodiments may include a flexible framework so that the controller 3610 conforms to, and lays more flat against, the body of the user. Shown here are fabric pre-filter shell 4402 and battery module 4404.

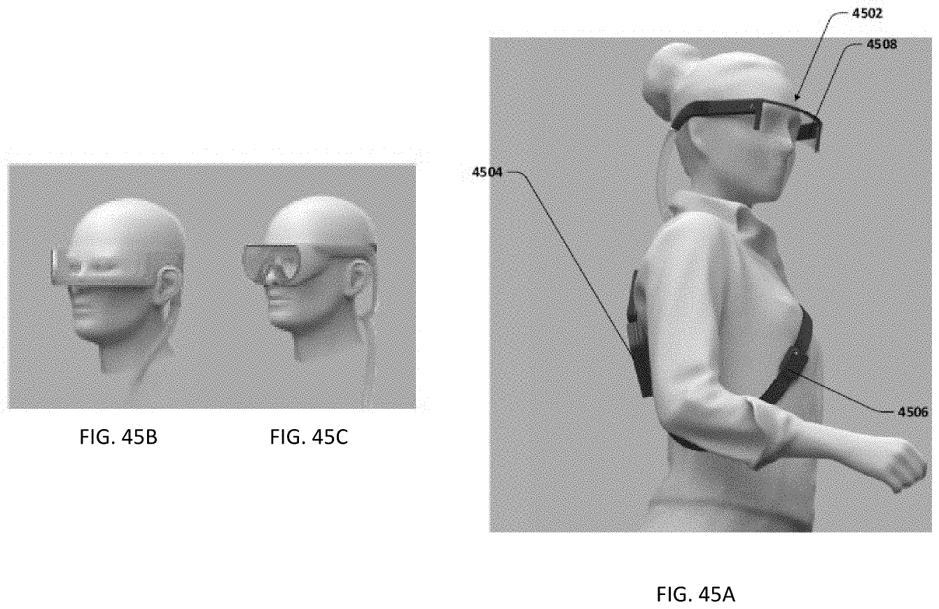

FIGS. 45A-C show another embodiment of the isolation system. This embodiment includes goggle 4502 which is worn over the eyes. The transparent shield of the goggle may include two layers of transparent material, between which filtered air may flow downward. As with other embodiments disclosed herein, this embodiment may be modular, including the ability to add a face shield. As with other embodiments disclosed herein, this embodiment may be designed to accommodate eyewear worn by the user. Alternatively transparent shield 4508 of the google may incorporate a prescription into the lens of the shield. Shown here also is air filter/supply 4504 as well as controller 4506, both attached to a cross body strap.

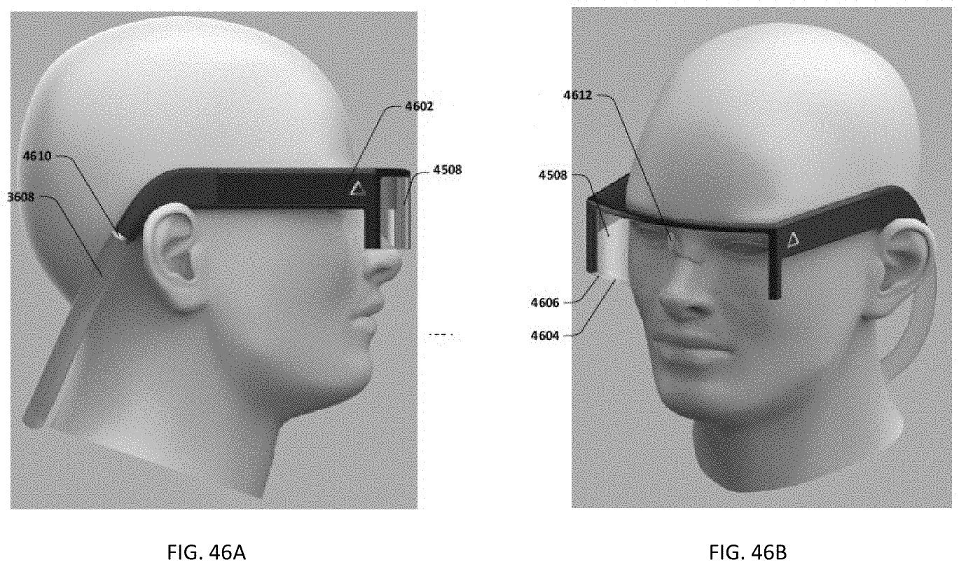

FIGS. 46A and 46B show the embodiment of FIG. 45 close up. Transparent eye shield 4508 includes inner layer 4604 and outer layer 4606. Filtered air flows from the filtered air source through supply tube(s) 3608, through frame 4602 and between inner lens layer 4604 and outer lens layer 4606 downward over the nose and mouth area of the user. Also shown here is frame/tubing connector 4610 and support 4612.

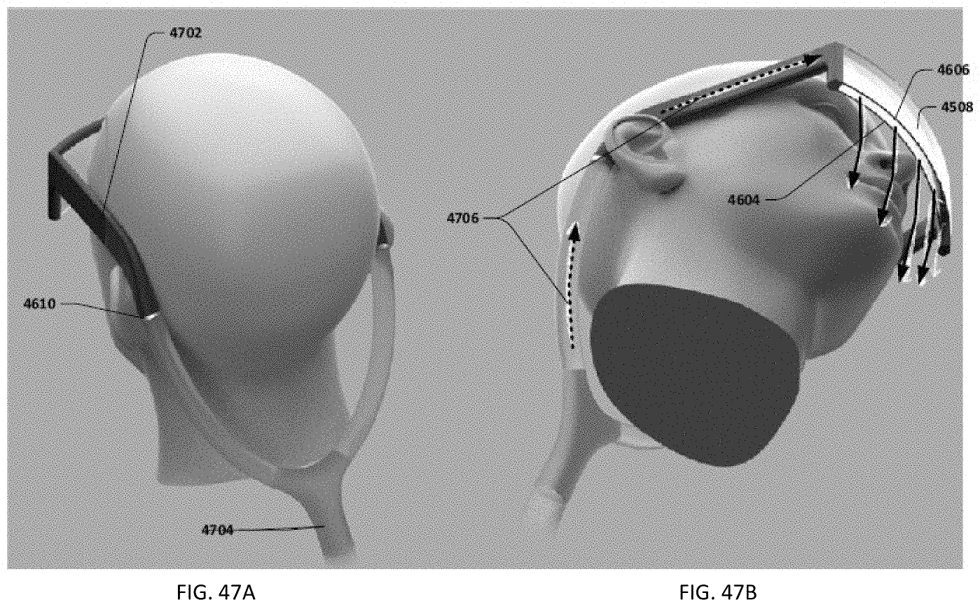

FIGS. 47A and 47B show other views of the embodiment shown in FIG. 45. Connector 4610 may be a magnetic attachment, or mechanical or other attachment. The direction of the air flow over the face of the user may be directed toward the face and downward. The directionality may be set by the curvature or opening configuration of eye shield 4508, or may be configurable by the user. For example, the eye shield may comprise a double lens, where outer lens layer 4606 may be longer than inner lens layer 4604, and/or one or both lens layers may curve inward slightly. Alternatively, eye shield 4508 may be adjustable, for example, the user may be able to angle the entire eye shield toward or away from the face. Also shown here is flattened hollow structures 4702, y splitter 4704 and the flow path 4706 of filtered air flow.

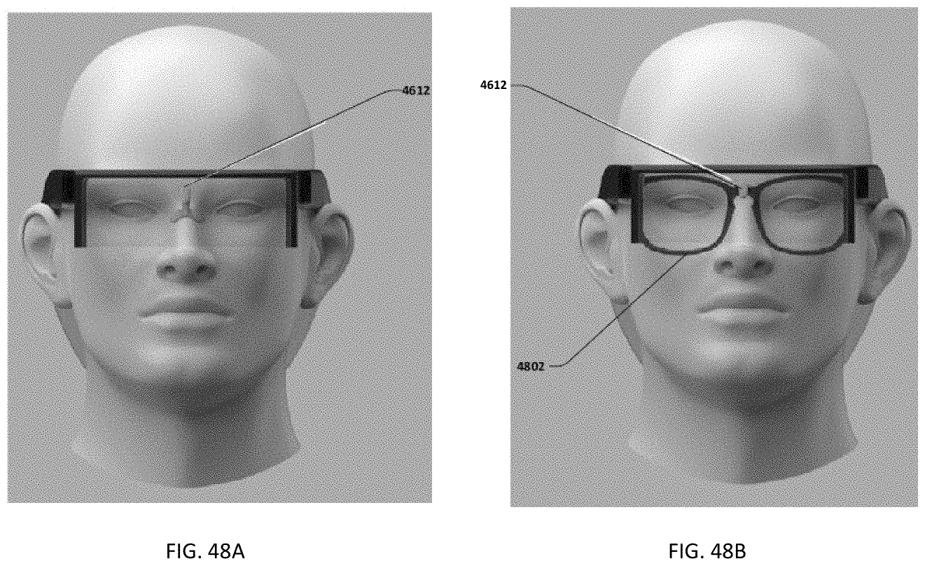

FIGS. 48A and 48B show the isolation system in use with and without eyewear. Replaceable support 4612 is shown supporting the device without eyewear on the left, and with eyewear 4802 on the right. The support device supports the isolation device so that it is stable, either with respect to the user's nose bridge, or forehead, or with respect to the user's eyewear or both.

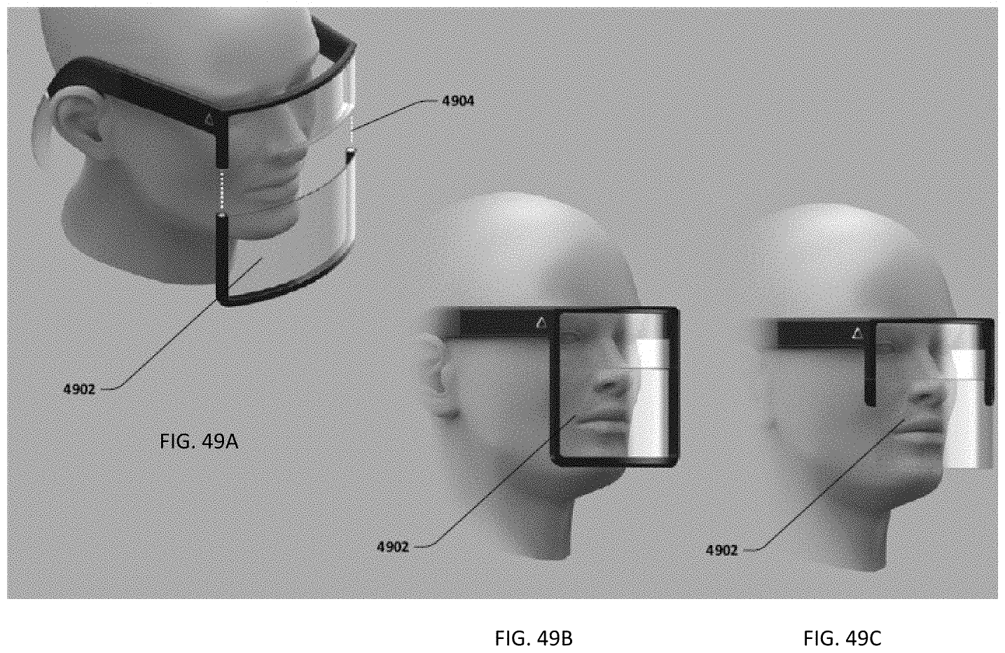

FIGS. 49A-C show an embodiment of the isolation system with detachable/attachable face shield 4902. The face shield may be attached to the eye shield via connecter 4904. Connecter 4904 may be a magnetic connection, a mechanical connection of other type of connection. In some embodiments, the transparent lens of face shield 4902 aligns with outer lens layer 4606 of the eye shield. The face shield may be a single layer, so that the filtered air flow, exits the double layer of the eye shield, and flows over the nose and mouth of the user, and face shield 4902 acts as at least a partial barrier between the filtered air and the outside environment. Note that in any embodiment disclosed herein, the eye shield and/or face shield may not seal against the face, leaving the face unobstructed, so that the user may freely speak, and even eat and/or drink with the device in place. In addition, the user does not feel the discomfort of a device touching his/her face. Some embodiments may include a seal against the face, either fully or partially.

FIGS. 49A-C show two variations of face shield 4902, one with a full outer frame and one with a partial outer frame. Variations without a frame are also envisioned. Face shield 4902 may be a separate piece, or may be built into the eye shield component of the device. For example, the face shield may rest above the eye shield when not in use, and may be pulled or slid down when needed. The face shield may also be made from a flexible material which may be folded or rolled and unfolded or unrolled when needed. The face shield may be transparent or may be translucent or may be opaque.

FIGS. 49A-C show the face shield connecting to the bottom of the eye shield, however, the face shield may alternatively connect to the top of the eye shield. In some embodiments, the face shield may be swappable for the eye shield.

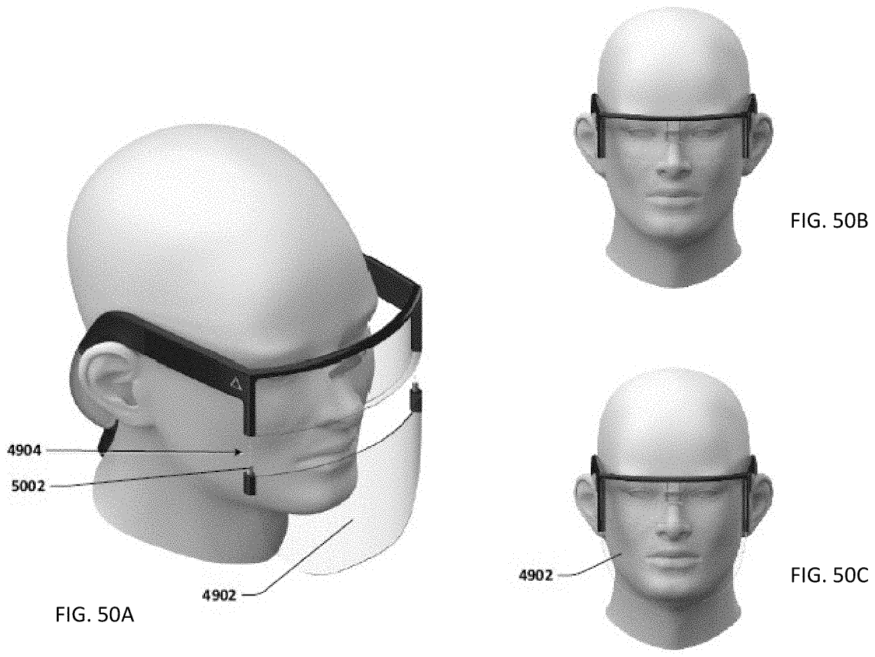

FIGS. 50A-C show more detail around connecter 4904. The connecter here includes male extension 5002 on face shield 4902 which is received by a female opening in the frame of the eye shield (not shown). Connecter 4904 may be magnetic or mechanical. The length of male extension may be from around 2 mm to around 1 cm. connecter 4904 serves both the connect the face shield to the eye shield, and also to align the two components, so that the face shield is aligned with the outer lens layer of the eye shield.

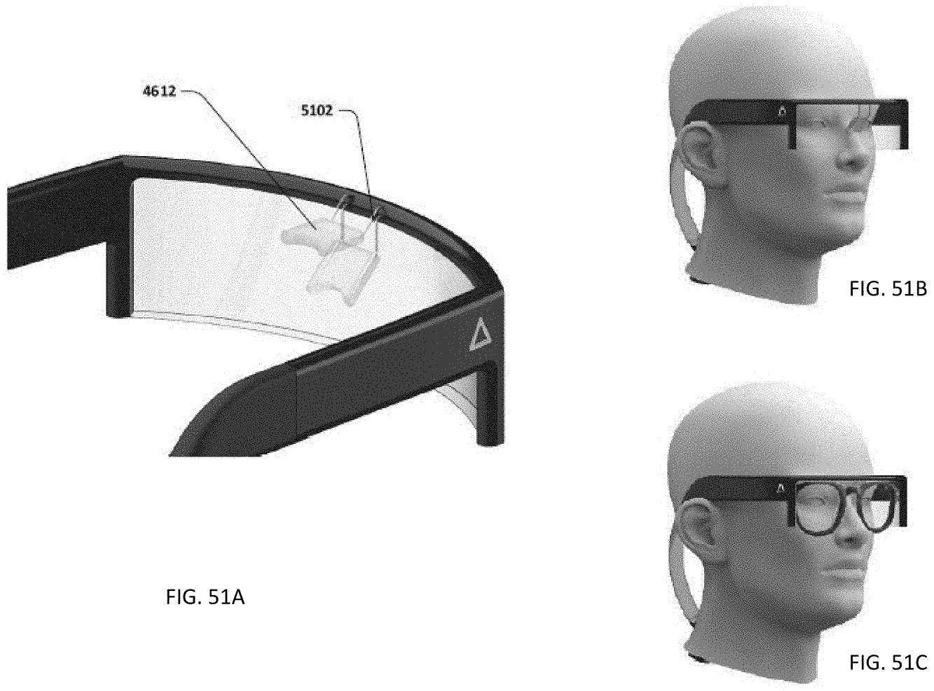

FIGS. 51A-C show an additional variation of support 4612. In this variation, support 4612 is connected the frame of the eye shield via deflectable connecter 5102 so that the support may be bent forward when in use, and bent toward the lens when not in use. The deflectable connector may also be used to adjust the fit of the support against the user or the user's eyewear.

The weight of the eye shield of any of the embodiments disclosed herein may be around 20 g to around 40 g.

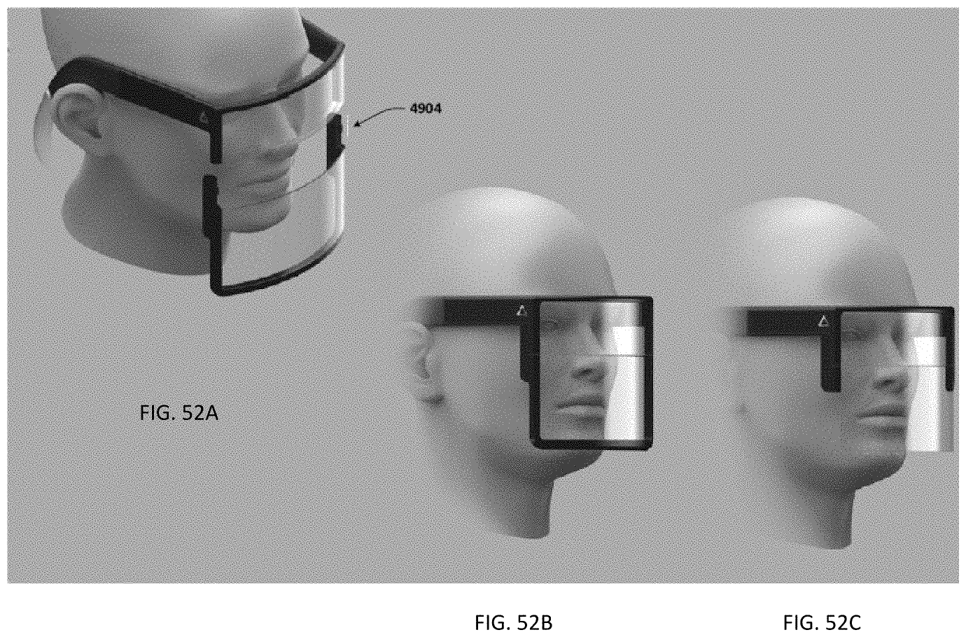

FIGS. 52A-C show an embodiment of the isolation device where connection 4904 is a mechanical connection.

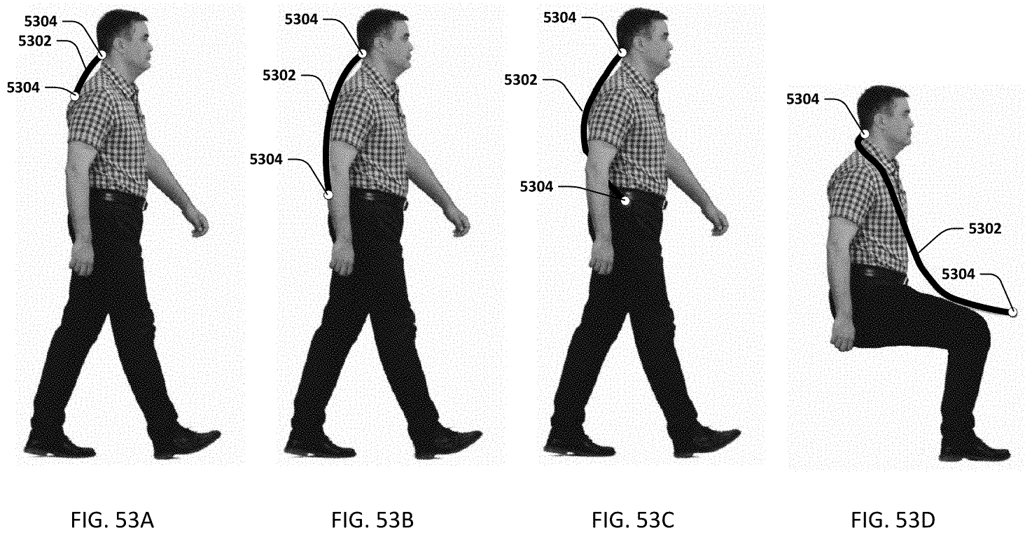

FIGS. 53A-D show some considerations and lengths for filtered air supply hose 5302 terminating in connectors 5304. The length of the supply hose may be dictated by the location(s) of the air supply/controller. For example, the air supply and/or controller may be worn on the user's back, on the user's waist, on the user's side waist, in the user's pocket, or may be placed separately from the user, for example, in an airplane seat pocket. The length of hose 5302 may be sized to accommodate one or more of these situations, for example, the hose may be a fixed length, may be interchangeable for different length hoses, or may have an adjustable length. The length of the hose may be around 9 inches, as shown in FIG. 53A, around 25 inches, as shown in FIG. 53B, around 32 inches, as shown in FIG. 53C, around 36 inches, as shown in FIG. 53D (which may be suitable for airline or other travel), or any other suitable length(s).

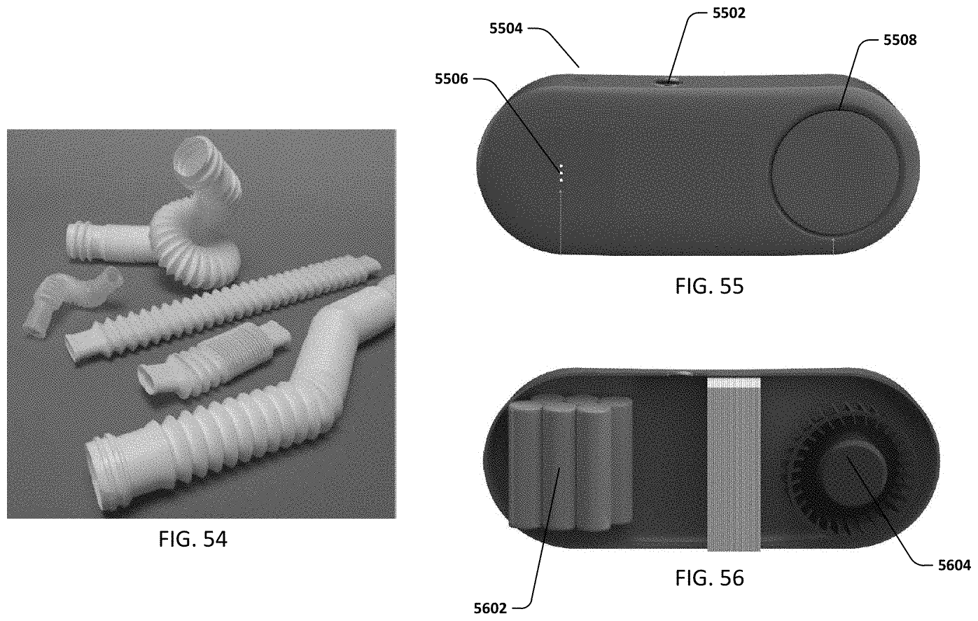

FIG. 54 shows some examples of extendable/compressible hoses, which may be adjusted to different lengths. These hoses have an accordion-like structure. Other designs may also be used, for example, concentric tubes which can be slid with respect to one another to length or shorten the overall hose length.

FIG. 55 shows an example of controller/air supply/filter 3610. Shown here is hose interface 5502, control area 5504, LED indicator lights 5506 and air intake area 5508.

FIG. 56 shows the controller/air supply/filter of FIG. 55 with the case cover removed. Shown here is battery (batteries) 5602 and fan 5604. The dimensions of controller 3610 may be around 9.5″×3.75″×1.5″.

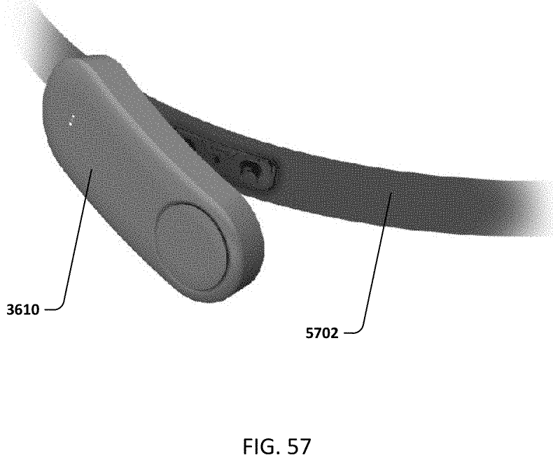

FIG. 57 shows an example of a connector between controller/air supply/filter 3610 and strap 5702. This connection may be a mechanical connection, a magnetic connection or any other type of appropriate connection. In any of the embodiments disclosed herein, any of the connections may be a combination of a mechanical and a magnetic connection, such as a Fidlock® connector (Fidlock is a registered trademark of Fidlock GmbH LIMITED LIABILITY COMPANY FED REP GERMANY.

FIGS. 58A-C show some different hose lengths for different device placement scenarios. FIG. 58A shows a 19″ hose length, FIG. 58B shows a 24″ hose length, and FIG. 58C shows a 22″ hose length. In some embodiments, the hose ID is around 15 mm.

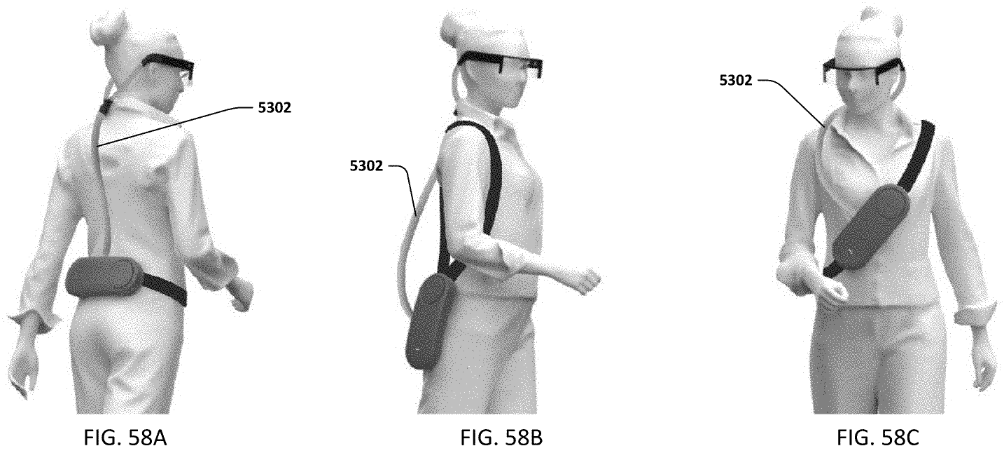

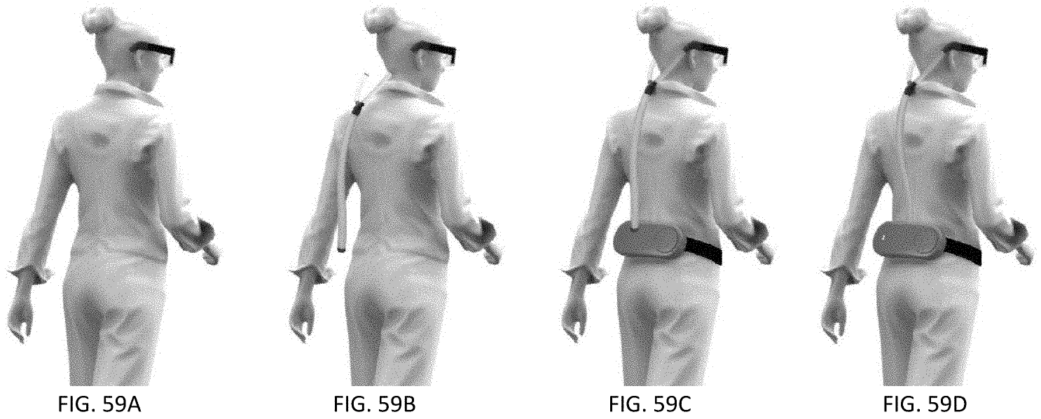

FIGS. 59A-D show some example steps that may be used to donning and starting the device. FIG. 59A shows step 1: putting headgear over the head. FIG. 59B shows step 2: attaching Y-hose to the headgear. FIG. 59C shows step 3: strapping the controller/air supply on to the waist. FIG. 59D shows step 4: connecting the hose to the controller/air supply and starting the device.

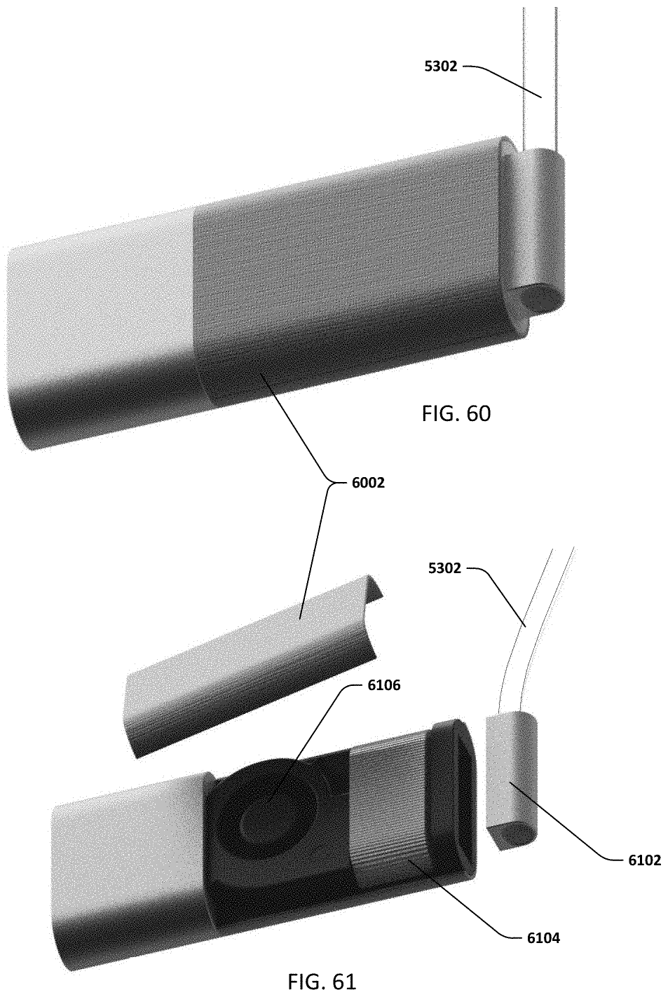

FIGS. 60 and 61 show an example of controller/air supply/filter 3610. Fabric pre-filter shell 6002 may be detached and machine washed. Hose connecter 6102 may be a quick release connector and connects hose 5302 to the controller. The controller body may include electronics and battery(s) in addition to filter 6104 and fan 6106.

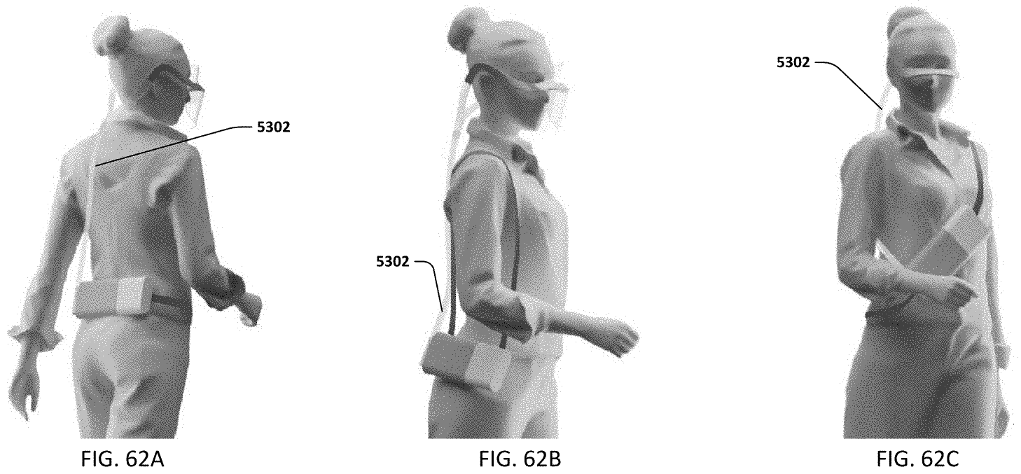

FIGS. 62A-C show some different hose lengths for different device placement scenarios. FIG. 62A shows a 19″ hose length, FIG. 62B shows a 24″ hose length, and FIG. 62C shows a 22″ hose length. In some embodiments, the hose ID is around 15 mm.

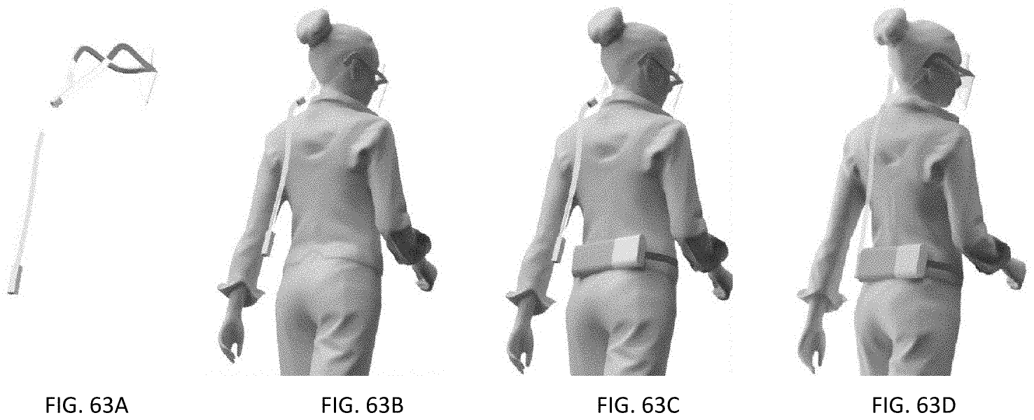

FIGS. 63A-D show some example steps that may be used to donning and starting the device. FIG. 63A shows step 1: connect headgear to main hose. FIG. 63B shows step 2: Put on headgear. FIG. 63C shows step 3: Strap controller/air supply on to body, for example on to waist. FIG. 63D shows step 4: connect the hose to the controller/air supply and start the device.

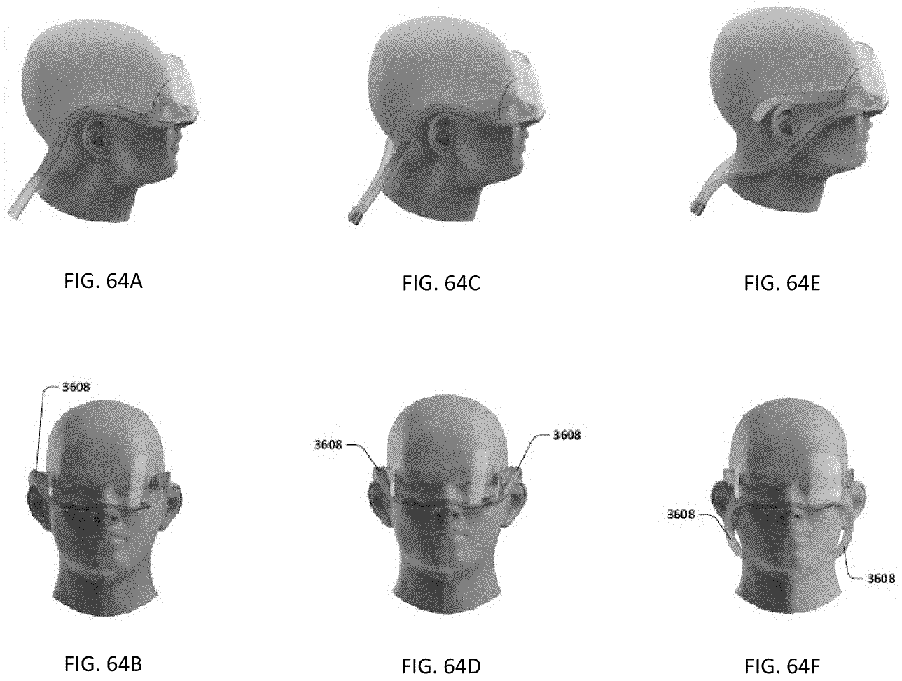

FIGS. 64A-F show some different routing of supply tube(s) 3608. Shown here is a single supply tube routed over the ear, 2 supply tubes routed over the ear, and 2 supply tubes routed under the ear.

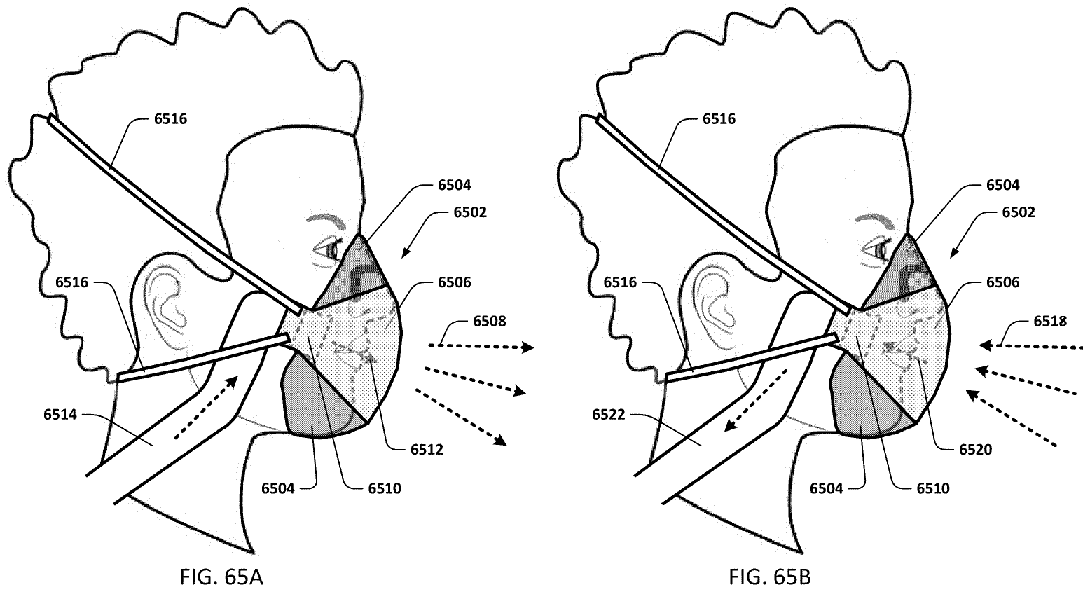

FIG. 65A shows another embodiment of the isolation device. The isolation device includes both passive and active filtration. The active filtration is powered by a motor and fan, where the passive filtration is performed by at least a portion of the mask material. The isolation device includes mask 6502, which has 3 sections. Two of the sections, the lower and upper sections, sections 6504, are manufactured out of a material or materials relatively impervious to air, such as neoprene, or other suitable materials. The third section, the middle section, section 6506, is manufactured out of a material, or materials, which serve as an exhalation filter, to filter exhaled air 6508. Mask 6502 may seal fairly closely to the face so that exhaled air is, at least in part, forced to exit through section 6506, so that people around the user are protected from contaminates in the exhaled breath of the user. Mask 6502 may include a combination of filter(s) and director(s), such as those shown in other embodiments herein.

Also shown here is positive pressure air (which may or may not be filtered) supply tubing 6514, which connects to air supply flange 6510 which supplies air 6512 to the interior of the mask. Straps 6516, to secure the mask to the head, are also shown. Flange 6510 may be made from a rigid material and may be relatively flat, to sit conformably inside the mask and against the face of the user.

This embodiment is designed to protect both the user and those around the user. The positive pressure filtered air protects the user from contaminates (active filtration). The filter built into the mask protects others from contaminates (passive filtration).

In some embodiments, the direction of airflow used with active filtration may be reversed. For example, in some environments, it is more important to actively filter (i.e. with motor and fan) the inhaled air, where in some environments, it is more important to actively filter the exhaled air. Or the requirements for the filter type for the inhaled air and exhaled air may be different, and may change.

FIG. 65B shows an embodiment similar to that shown in FIG. 65A where the airflow has been reversed at the controller. In this embodiment, the controller is supplying negative pressure air flow to the mask, so that external air 6518 is filtered by mask section 6506. Exhaled breath is pulled into flange 6510 and through exhaust tubing 6522 and through the fan/filter at the controller. The filter in the controller may be a HEPA filter or other filter. In the case where the mask is a courser filter than the HEPA filter, reversing the airflow can change the relative filtering of inhaled air and exhaled air.

For example, when a person is in close proximity to healthy people, it may be more important to tightly filter the exhaled air, and less important to tightly filter the inhaled air. In this situation, a HEPA filter may be in the controller, the controller may pull a negative pressure from within the mask through the HEPA filter in the controller, and the mask itself may perform as a courser filter, such as a droplet filter, for inhalation, as shown in FIG. 65B.

Alternatively, when a person is in close proximity to sick people, it may be more important to tightly filter the inhaled air, and less important to tightly filter the inhaled air. In this situation, a HEPA filter may be in the controller, the controller may apply HEPA filtered positive pressure air into the mask, and the mask itself may perform as a courser filter, such as a droplet filter, for exhalation, as shown in FIG. 65A.

In some embodiments, either inhalation or exhalation may have no filter, or may have filters of different types, including the ability to change out filters. In some embodiments, the system is closed loop, so that both negative pressure and positive pressure are supplied to the mask area.

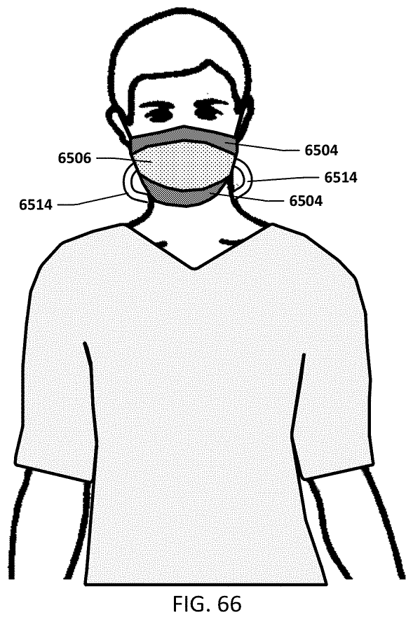

FIG. 66 shows the embodiment of the isolations system shown in FIG. 65A or 65B as worn by the user. In this figure, hoses 6514 (or 6522), are worn behind the neck, and attach to a filtered air source worn on the back, such as in a backpack or strap, or on the neck of the user. Note that the tubes may also be worn in front of the user, for example when the user is sitting in an airplane, so that there is nothing of bulk behind the user.

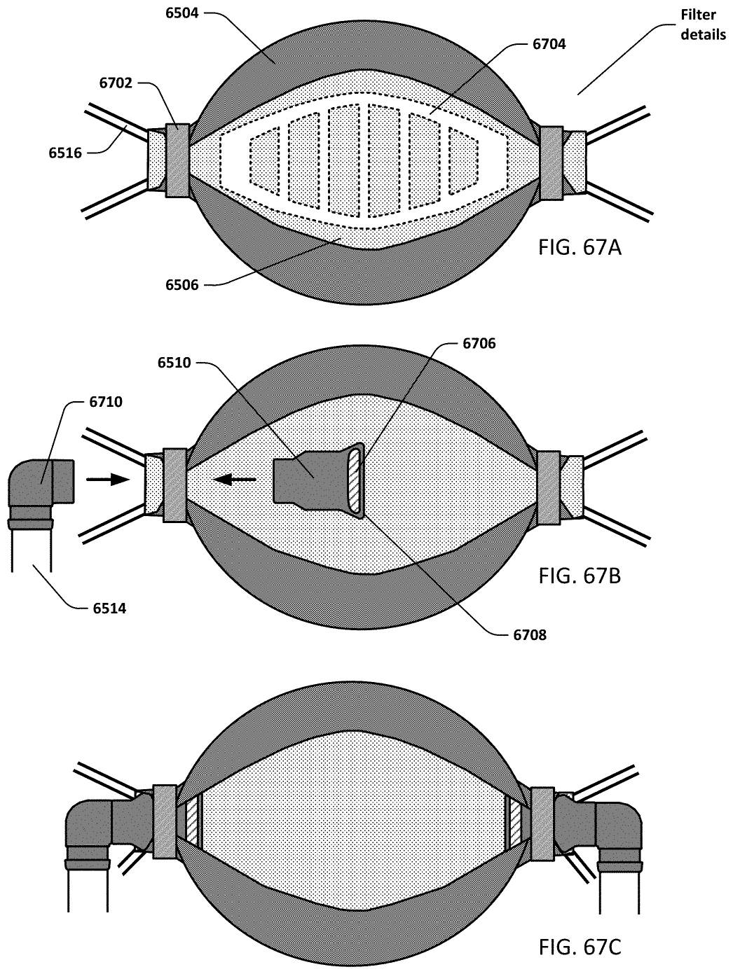

FIGS. 67A-C show detail of the mask are of the embodiment shown in FIGS. 65 and 66. These figures show the face-facing side of the mask. Sections 6504 may be unfolded so that the mask may be placed on the user's face. Section 6506 is the filter section of the mask. The filter section of the mask may be made of more than one material or more than one layer of materials. For example, shown here is scaffolding 6704 which may be made of a polymer and may provide some rigidity to the mask. The rigidity helps hold this section of the mask away from the nose and mouth, so that incoming air may circulate around the nose and mouth for breathing. The rigidity may also help with exhalation, by allowing the full surface area of section 6506 to be available for exhalation.

Section 6506 may include a filter material as one of the layers. For example, a charged felt may be used. For example, Technostat electrostatic filter media may be used (Technostat is a registered trademark of Hollingsworth & Vose Company, East Walpole, Mass.). A charged filter material may help trap contaminates in the filter. A fabric filter, such as felt, allows the mask to be washable. It is also possible to recharge the charged filter material by applying heat, or an electrical force. Such a recharging may be achieved by drying the mask in a dryer, or by using a specific recharging base, in which the mask may be place, or to which the mask may be connected. The recharging base may also include other functions such as sterilization (for example via UV light) and battery charging.

In some embodiments, filter section 6506 may be made of multiple layers, such as an internal comfort layer, such as cotton, an internal filter layer, such as a charged felt material, a scaffolding, and an external later. The layers other than the filter layer may be fairly permeable to air. In some embodiments, different layers filter different types of particles/contaminates.

In some embodiments, the filter section of the mask, or other portions of the mask, may be made from multiple layers for protection from liquids, or contaminates, for example blood. For example, one layer may be an electrostatic felt, one layer may be standard N95 mask material (such as a hydrophobic material, such as meltblown ePTFE), and/or one layer may be a meltblown polypropylene. Any combinations of materials may be used. In one example, a combination of a hydrophobic layer and an electrostatic felt layer is used over the mouth and/or nose of the user. Some embodiments of the mask may include an activated charcoal filter layer.

In some embodiments, the mask portion of the device may include one or more disposable layers. For example, the inner and/or outer layer of the mask may be made from a disposable material, and may be removable and/or replaceable. In this way, the mask may be used multiple times, possibly by multiple users, by protecting the user from contamination by a previous use or user. In some embodiments, the removable layer may be a “tear away” layer, which either leaves a non-contaminated layer behind, or can be replaced with a non-contaminated layer.

FIG. 67A also shows straps 6702 which are designed to hold to air supply flange 6510 in place during use.

FIG. 67B shows air supply flange 6510 and how it is inserted into straps 6702 of the mask. Flange 6510 includes air exit opening 6706, which preferable is angled, or placed on the side of the flange, so that air is directed inwardly toward the mouth and nose. However, embodiments without an angled or side opening are envisioned. There may be multiple exit openings in some embodiments. Flange 6510 has a widened area 6708 which is wider than strap 6702, so that the flange will not slip through the strap during use. The flange may be flattened so that the mask will remain snuggly against the user's face.

Also shown in FIG. 67B is elbow connector 6710 and air supply tubing 6514. Flange 6510 connects to elbow 6710 as shown so that the connection fits snuggly under strap 6702 at one or both sides of the mask. The fit between the two components may be a press fit, a snap fit, or some other sort of connection mechanism.

Note that in circumstances when the filtered air supply is not available, for example, when the battery is low, the person is passing through airport security, etc., the mask may still be used and still be effective. Hoses 6514 may be removed along with flange 6510. Once these two components are removed from the mask, the mask sits snuggly against the face and the filter section 6506 will serve as a filter both for inhalation and exhalation. Alternatively, flanges 6510 may remain in place, and may be sealed off with a cap or a valve, to not allow incoming air to enter the mask. For example, a simple magnetic cap may be used to seal up the flange opening, for example, opening 6902 shown in FIGS. 69A and B. alternatively, a membrane may be in place which seals when the flange is not connected to the elbow component, but opens when the two are connected.

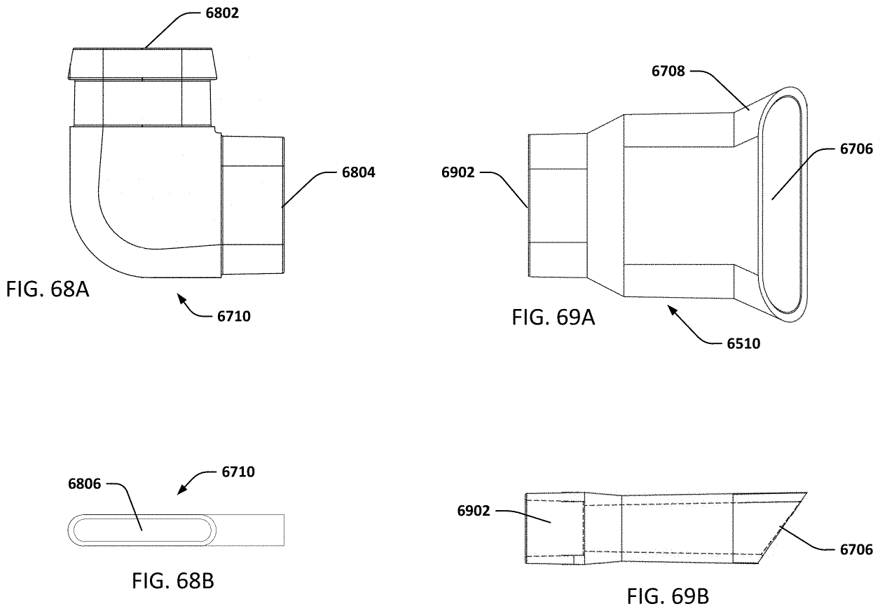

FIGS. 68A and 68B show a detail view of elbow connector 6710. FIG. 68A is a side view and FIG. 68B is an end view. Elbow connector 6710 has two ends, tubing connection end 6802 and flange connection end 6804. FIG. 68B shows tubing connection end 6802 with opening 6806. The elbow, and both connection ends may be flattened, so wide in one dimension and relatively narrow in the other. This helps the connecter sit closely near the face with a minimum of protrusion. The openings need enough area to allow adequate air flow, which is why it may be elongated in one direction. For example, the openings may be around 0.5-1.0 inches long in the longer direction, and 0.1-0.5 inches wide in the narrower direction. The elbow may be made of a rigid material, to maintain the openings and body in an open position so that air can flow freely through the internal air lumen. Alternatively, the elbow may be made from a softer material, such as silicone, which has reinforcements, to keep the airflow lumen, through the elbow, in an open position.

FIGS. 69A and 69B show flange 6510 in more detail. As with the elbow, the flange may be made from a rigid material or a reinforced softer material. The flange may also be generally flattened. Air exit opening 6706 is shown here at an angle to the body of the flange. This is to facilitate air flowing out of the opening and toward the space that surrounds the nose and mouth of the user. Elbow connection end 6902 is also shown, and similar to flange connecting end on the elbow, may be elongated in shape. Connection ends 6804 and 6902 connect to each other as shown in FIG. 67B.

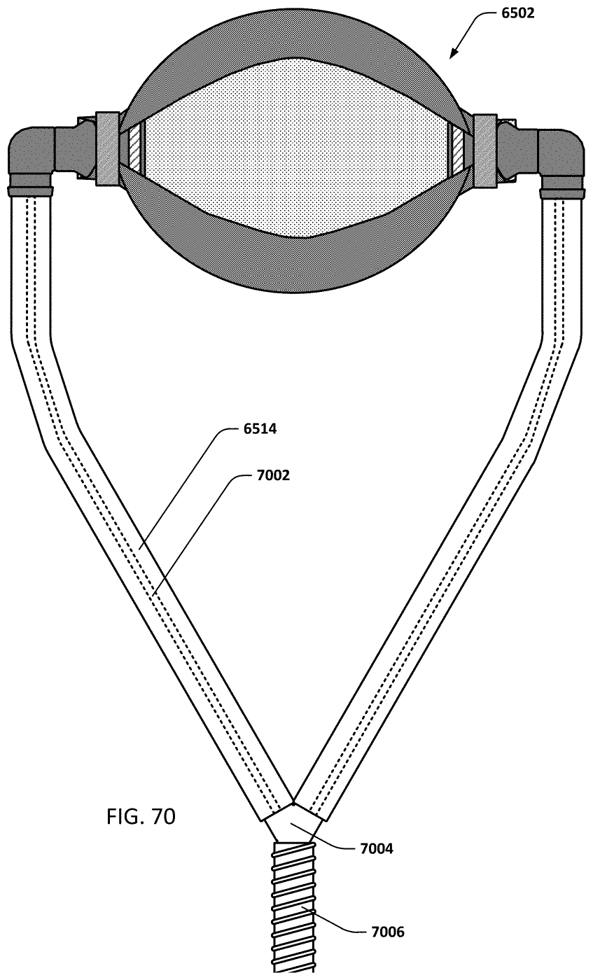

FIG. 70 shows mask 6502 connected to hoses 6514. Also shown is Y-connector 7004 and air feed tube 7006. The hoses and/or Y-connector may be round or flattened. Hoses 6514 may contain bendable/malleable element 7002, such as a strip of copper or brass, which allows the user to shape the hoses for maximum comfort. Hoses 6514 and 7006 may come in different lengths, or the lengths may be adjustable, for example with an accordion or sliding design. Two hoses are shown here, although some embodiments may have only one hose.

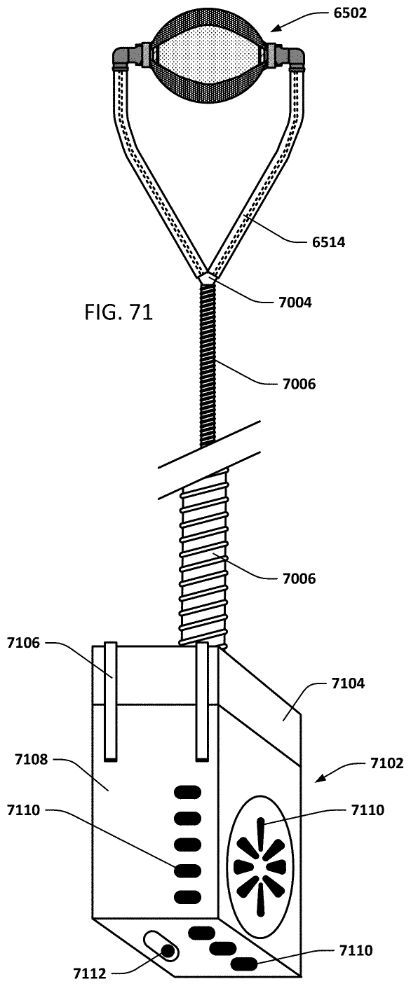

FIG. 71 shows air feed tube 7006 connected to controller/filter 7102. The controller may house the filter fan, filters, battery, electronics/controls, etc. filter pack 7104 may attach to the main body of the controller with flexible bands 7106. Air inlet vents 7110 may exist on one, some or all surfaces of casing 7108. Inlet filters on multiple sides helps avoid blocking the inlet vents when the controller is in a backpack, or up against the user. On/off button 7112 turns the device on and off. The controller may include a display, alerts, lights, etc.

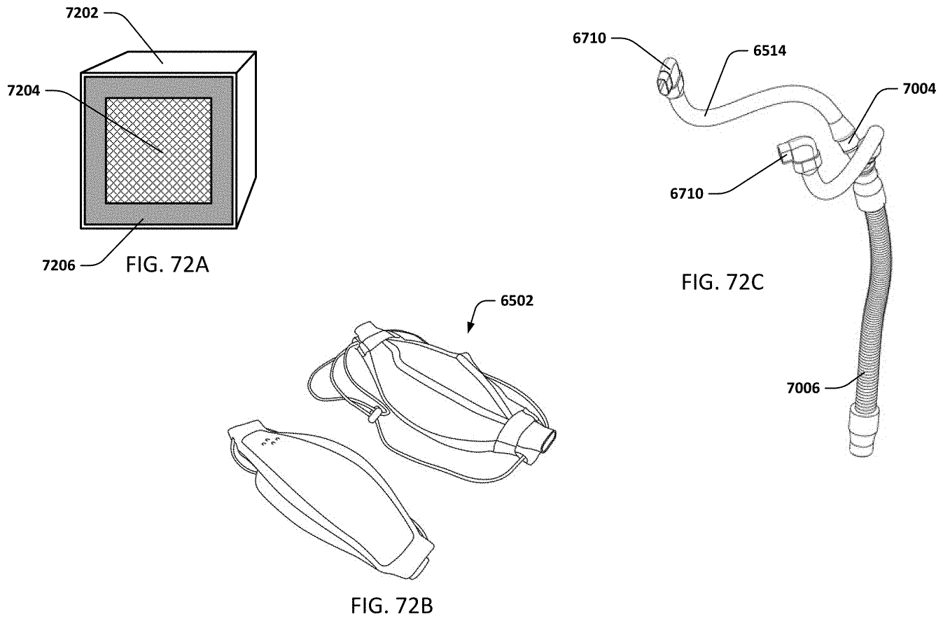

FIG. 72A shows a filter, such as a filter that may be placed inside filter pack 7202. The filter may include filter casing 7202, filter material 7204 and filter seal 7206. The filter material may include HEPA filter media, activated carbon or both. Other filter materials may also be used. The filter seal may be a soft material, such as silicone, foam, rubber etc., which forms an essentially airtight seal between the filter and the filter casing when the filter is installed. Alternatively, the filter casing may be disposable and include a permanently attached filter within. The filter may be designed to filter bacteria, viruses, allergens, particulate matter, VOCs etc. Different filters may be available to filter out different contaminates.

In some embodiments, the filter pack may accommodate filters of different sizes, different filtration levels, different materials, different filtration targets, filters designed for filtering exhaled air, filters designed to filter inhaled air, filters designed for short term use, filters designed for long term use, etc.

FIG. 72B shows another view of mask 6502.

FIG. 72C shows another view of the hose assembly.

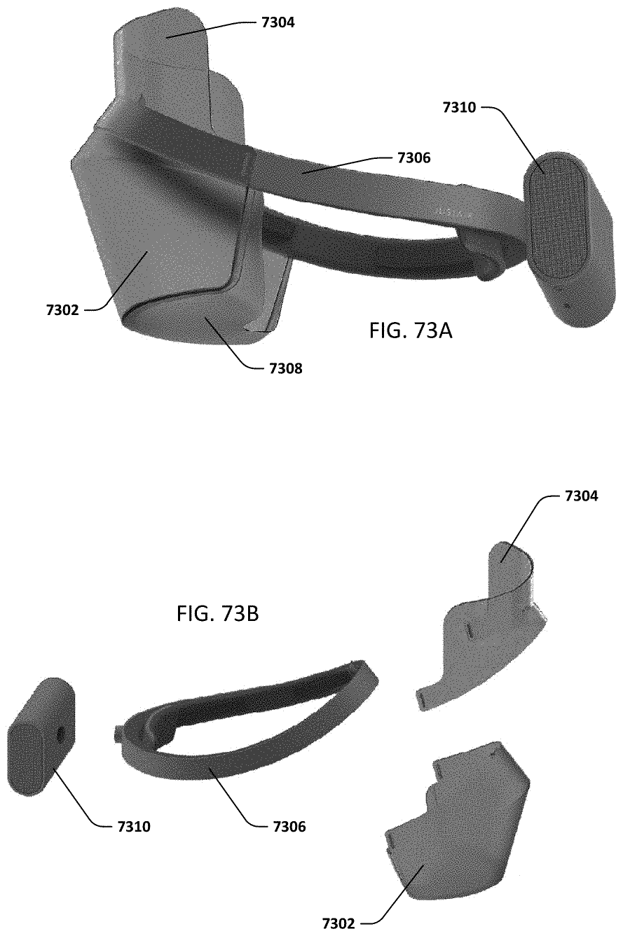

FIG. 73A shows another embodiment of the isolation system. Shown here are face shield 7302, eye shield 7304, ribbon or loop 7306, filter 7308 and mini module/controller 7310.

FIG. 73B shows an expanded view of the embodiment shown in FIG. 73A. Shown here are the loop/ribbon 7306, mini module (controller/filter) 7310, optional face shield filter 7308, eye shield 7304 and face shield 7302. This embodiment can be used without the face shield and eye shield, or it can be used with either the face shield or eye shield, or it can be used with both the face shield and the eye shield. Note that this embodiment may not require an air supply tube and may be worn completely on the head.

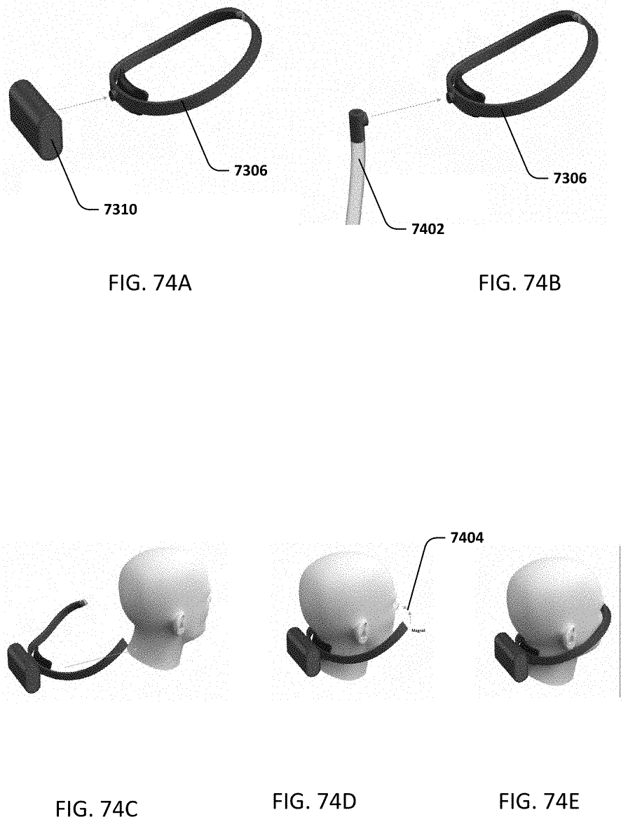

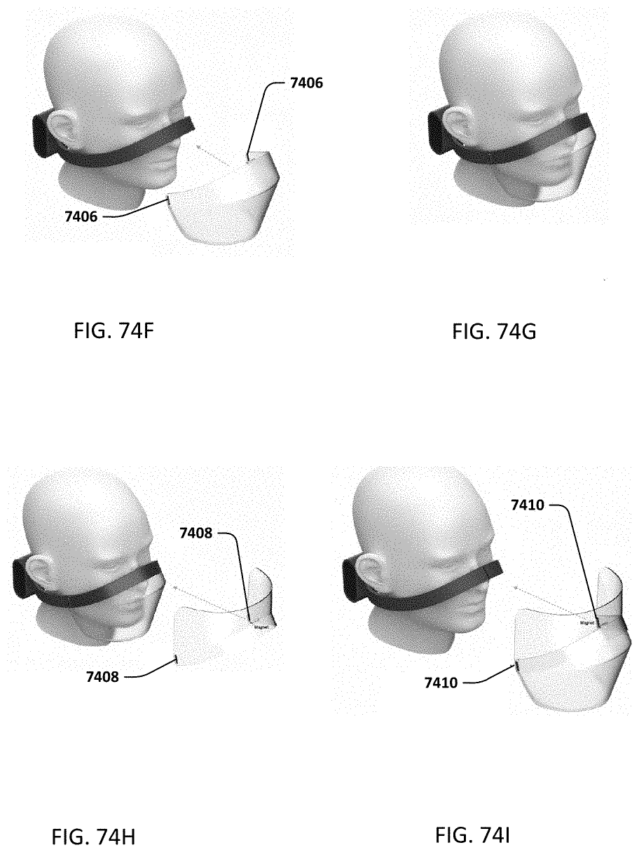

FIGS. 74A-74I show the donning process for the embodiment shown in FIGS. 73A and 73B. FIG. 74A shows mini module 7310 being attached to ribbon/loop 7306. This would be for embodiments that incorporate a neck worn mini module which may include a fan, controller, filter etc. FIG. 74B shows air flow hose 7402 being connected to ribbon/loop 7306. This would be for embodiments that incorporate a body worn controller/filter/fan. FIG. 74C shows the loop/ribbon, being placed on the head, where the mini module rests on the lower part of the neck. The loop may be connected in the front of the face via connector 7404, such as a magnet. This is shown in FIG. 74D. The loop/ribbon rests on top of the nose, as shown in FIG. 74E. FIG. 74F shows the attachment of the face shield to the ribbon/loop by aligning fasteners 7406, which may be magnets. FIG. 74G shows the device in place on the face. FIG. 74H shows the attachment of the eye shield to the ribbon/loop by aligning fasteners 7408, which may be magnets. FIG. 74I shows an embodiment where the eye shield attaches to the face shield via fasteners 7410, which may be magnets. The eye shield and the face shield may alternatively be a single component.

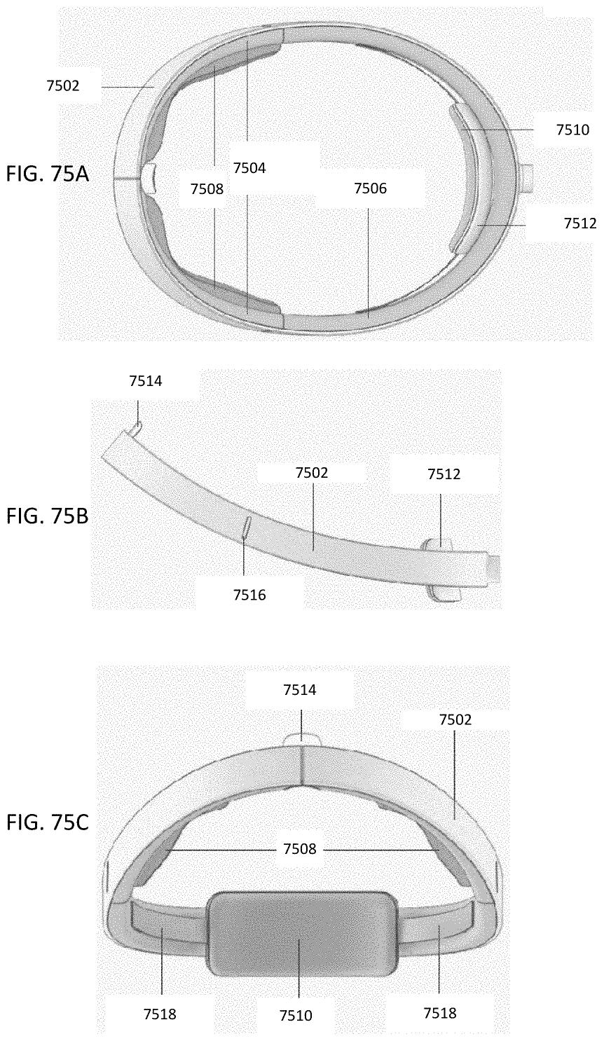

FIGS. 75A-C show detail of the loop component of this embodiment. Shown in FIG. 75A are loop exterior 7502, loop interior front 7504, loop interior rear 7506, pad 7508, which may be foam, or other soft flexible material, neck pad 7510 and neck pad cover 7512. Shown in FIG. 75B are nose pad 7514, magnet 7516, loop exterior 7502 and neck pad cover 7512. Shown in FIG. 75C are nose pad 7514, loop exterior 7502, foam pad 7508, neck pad 7510 and leaf springs 7518.

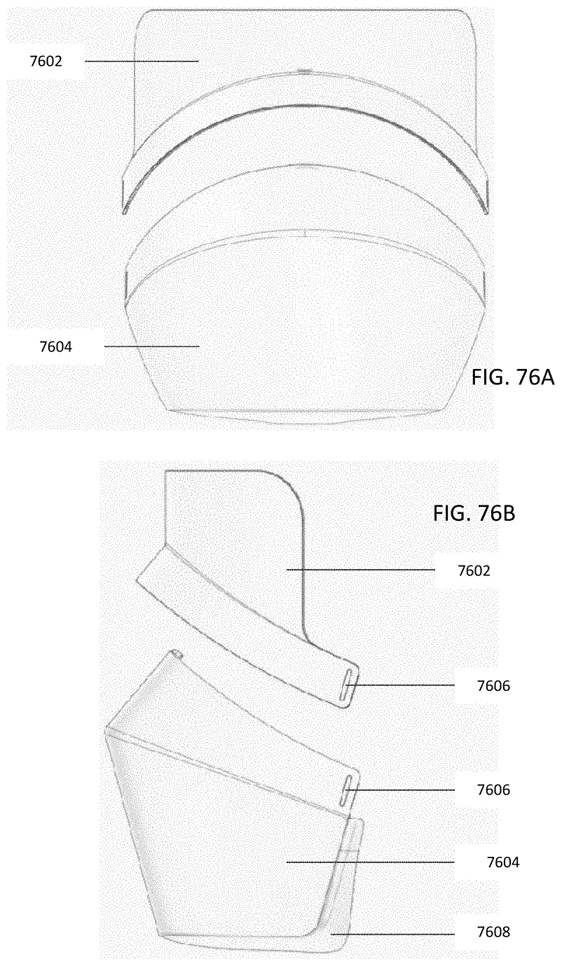

FIGS. 76A and 76B show detail of the eye shield, face shield and filter of some embodiments. Shown here are eye shield 7602, face shield 7604, magnets 7606 and filter 7608

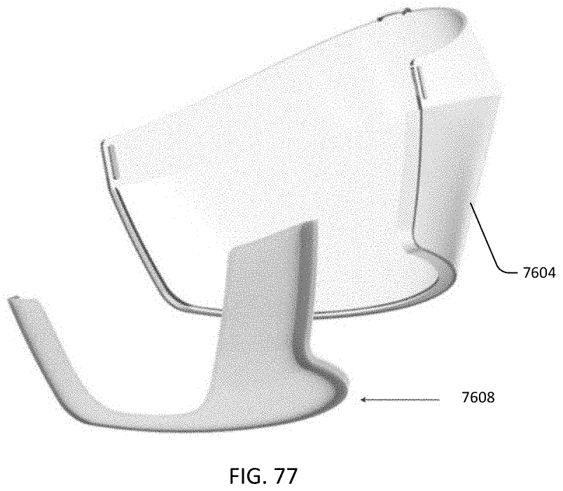

FIG. 77 shows details of the face shield and face shield filter of some embodiments.

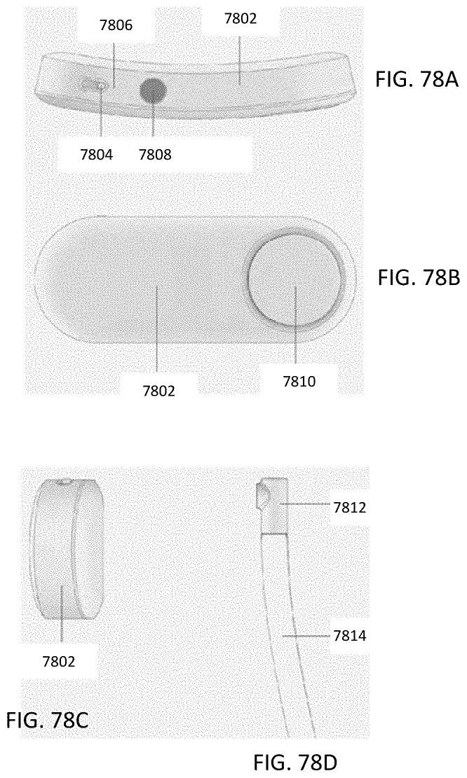

FIGS. 78A-D show details of the mini module/controller/filter of some embodiments. Shown here is main housing 7802, power switch 7804, LED indicator 7806, hose connector receiver 7808, vent cover 7810, hose connector 7812, and hose 7814.

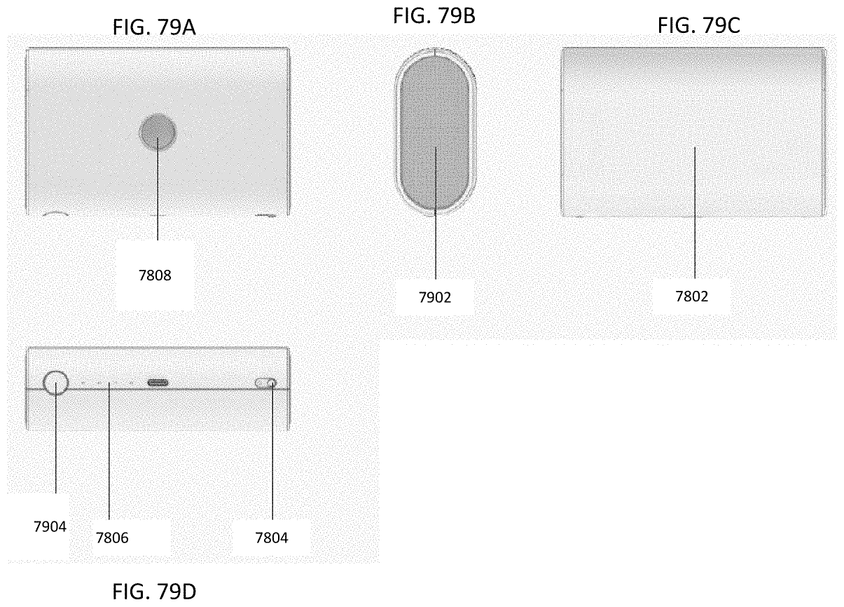

FIGS. 79A-D show more details of the mini module/controller/filter of some embodiments. Shown here in addition to components previously identified are air intake caps 7902 and battery level indicator button 7904.

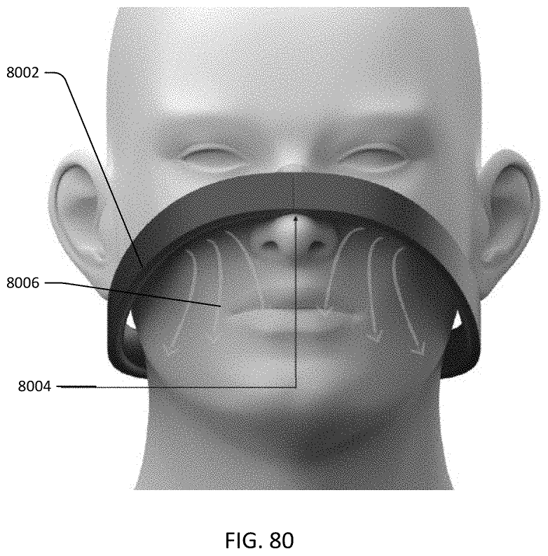

FIG. 80 shows the function of the loop component of some embodiments. There is a small gap between the wearer's cheek and the air outlet ports on the underside of loop 8002. This gap between the unit and the cheek creates a localized pocket of fresh air directly near the wearer's nose/mouth, indicated by airflow 8006. In addition, it allows maximum room for eyeglasses, and accommodation for various face shapes. Also visible here is the decrease in thickness of the loop over the wearer's nose, indicated at 8004. The left/right sides of the loop may not form a complete air channel. The air paths may end at their outlet ports next to the nose, allowing the loop to sit as low profile as possible over the wearer's nose for limited visual impairment.

Some embodiments of the isolation system may include sensors to monitor the system, and/or the user. For example, the mask may include sensors, the controller may include sensors, the tubing may include sensors and/or sensors may be connected to any of these or any of the components. Sensors may include pressure sensors, flow sensors, temperature sensors, blood oxygen sensors, pulse oximeter, microphones, ECG sensors, cameras, accelerometers etc. Sensors may sense respiratory rate, heart rate, blood oxygen level, temperature, color, etc. For example, measuring respiratory rate may be done using a pressure or flow sensor, or microphone. Heart rate may be measured using a pulse oximeter, ECG sensor, etc. Temperature may be sensed using a temperature sensor. Controller and/or air supply/filter position and/or operation may be sensed using temperature sensors, accelerometers etc.

In some embodiments, sensors sense filter usage time or filter clogging, to alert the user when new filter is required. Identification of components, such as RFID of the disposable filter, or mask, battery, or other components, may be used, to make sure only correct parts are being used with the device. The identification of the filter could be performed by current level in the fan after the filter is installed, to make sure it has the correct resistance.

In some embodiments, an alert may alert the user to specific situations, including: filter needs changing, mask is too loose or not property fitted (which may be sensed using a flow or pressure sensor), replace or recharge the battery, excessive CO2, respiratory rate is too rapid for system to accommodate (for example the system may ask the user to rest),

In some embodiments, the isolation system is designed for ease of verbal communication. For example, the fan motor and/or fan may be placed remotely from the user's face, to minimize motor noises during talking. Also, the material of the mask may be designed to allow verbal communication through the mask when the device is operational. Also, the design of the air inlet lines/ports may be such that they do not impede verbal communication. For example, the air inlet lines may enter the mask at the edge(s) of the mask, so that they do not impede mouth movement, or sounds coming from the mouth. The incoming airflow rate and the shape of the air inlet ports may be designed to minimize air inlet noises. The fan motor may be designed to minimize motor noise. The result for the isolation system is an acceptable Modified Rhyme Test (MRT) score. For example, the MRT score may be above 95%. Alternatively, the MRT score may be above 91%. Alternatively, the MRT score may be above 90%. Alternatively, the MRT score may be above 85%. Alternatively, the MRT score may be above 80%. Alternatively, the MRT score may be above 70%. Alternatively, the MRT score may be above 60%.

In some embodiments, the CO2 level and/or temperature level within the mask component, or within other areas of the system, is monitored and/or controlled. For example, CO2 sensors, or temperature sensors may be incorporated into the mask or elsewhere. If CO2 and/or temperature levels are too high, the controller may increase the fan power to increase the flow of air to the mask. The controller may monitor the CO2 and/or temperature level to determine when the motor power may be reduced.

In some embodiments, the device fails in a safe manner. For example, if the battery dies and the user doesn't have access to a power outlet, the user may remove the tubing(s) from the mask, seal the tubing openings, either manually or automatically, and breath naturally through the mask. The mask may continue to filter inhalation and/or exhalation in an unassisted manner.

In some embodiments, the user may choose to use the device at a low power level or without power, to save on battery life or when access to power is not available. In these embodiments, the filter material of the mask will still function as a filter for air being inhaled and/or exhaled. Because the mask material, or layers of materials, function as a filter, less power may be necessary. Also, power may be able to be conserved when the user is relatively inactive, and increased, when the user is more active. In this way, the filtering qualities of the mask material may be supplemented by the fan/HEPA filter as necessary given the environment and activity level of the user. In some embodiments, the filtration level of the mask, used without power to the fan, is at least as effective as a standard N95 mask, meaning it filters at least 95% of airborne particles. See U.S. National Institute for Occupational Safety and Health (NIOSH) N95 classification of air filtration.

In some embodiments, the user may be able to direct his/her inhalation and/or exhalation. For example, when a user is sitting in the window seat on a plane, he/she may want to direct both inhalation and exhalation toward the window. Some embodiments have baffles, or external flanges, which may be directed to a side, up, down, back, or forward from the user. In some embodiments, one or more inhalation and/or exhalation ports may be blocked to direct the air flow.

In some embodiments, one controller may control more than one device. For example, two users sitting next to each other on a plane may share the same controller.

In some embodiments, the controller incorporates wireless communication so that some of the functions of the controller may be performed remotely, on a mobile phone, computer, tablet etc.

In some embodiments, the noise produced by the controller fan is below around 60 dB. In some embodiments, the noise produced by the controller fan is below around 65 dB. In some embodiments, the noise produced by the controller fan is below around 58 dB. In some embodiments, the noise produced by the controller fan is below around 56 dB.

In some embodiments, the airflow produced by the device is around 115-170 liters per minute. In some embodiments, the airflow produced by the device is around 115-250 liters per minute.

In some embodiments, the device includes a clip or holster to hold the weight of the tubing so that the weight is substantially off the user's face.

Each of the individual variations described and illustrated herein has discrete components and features which may be readily separated from or combined with the features of any of the other variations. Modifications may be made to adapt a particular situation, material, composition of matter, process, process act(s) or step(s) to the objective(s), spirit or scope of the present invention.

Some embodiments of the isolation system include meeting certain filtration standards. For example, the system may need to meet a minimum filtration requirement for inhalation and/or for exhalation. The system may need to meet certain flow rate standards. The system may need to meet certain mask pressure standards, including inhalation pressure and/or exhalation pressure. The system may need to meet certain communication recognition standards. The standards may be different for inhalation and exhalation. The standards may be determined using test protocols approved by the national Institute for Occupational Safety and Health (NIOSH). See also “Statement of Standard for Chemical, Biological, Radiological, and Nuclear (CBRN) Powered Air-Purifying Respirators (PAPR)” for references to standard test protocols.

In some embodiments the minimum filtration requirement for inhalation is 95% (meaning the filter filters at least 95% of airborne particles). In some embodiments the minimum filtration requirement for exhalation is 95%. In some embodiments the minimum filtration requirement for inhalation is 99%. In some embodiments the minimum filtration requirement for exhalation is 99%. In some embodiments the minimum filtration requirement for inhalation is 90%. In some embodiments the minimum filtration requirement for exhalation is 90%. In some embodiments the minimum filtration requirement for inhalation is 85%. In some embodiments the minimum filtration requirement for exhalation is 85%. In some embodiments the minimum filtration requirement for inhalation is lower than the minimum filtration requirement for exhalation. In some embodiments the minimum filtration requirement for inhalation is higher than the minimum filtration requirement for exhalation. In some embodiments the minimum filtration requirement for inhalation and the minimum filtration requirement for exhalation can be toggled so that the user can choose whether inhalation or exhalation has a higher filtration.

In some embodiments, the minimum air flow rate requirement is 90 liters per minute. In some embodiments, the minimum air flow rate requirement is 80 liters per minute. In some embodiments, the minimum air flow rate requirement is 100 liters per minute. In some embodiments, the minimum air flow rate requirement is 60 liters per minute.

In some embodiments, the maximum exhalation pressure requirement is 100 mm H2O. In some embodiments, the maximum exhalation pressure requirement is 200 mm H2O. In some embodiments, the maximum exhalation pressure requirement is 500 mm H2O. In some embodiments, the maximum exhalation pressure requirement is 1 cm H2O. In some embodiments, the maximum exhalation pressure requirement is 2 cm H2O. In some embodiments, the maximum exhalation pressure requirement is 500 mm H2O.

In some embodiments the minimum communication standard is 90%. In some embodiments the minimum communication standard is 80%. In some embodiments the minimum communication standard is 75%. For an example of testing protocol, see “NIOSH Procedure No. CVB-APR-STP-0089”.

In some embodiments, the filter element of the device protects the user against oil. In some embodiments, the filter element of the device is not required to protect the user against oil.

In some embodiments, the mask portion of the device functions effectively as a passive face mask, for example, as effective as an N95 mask, without the fan running. The mask portion of the device may pass a fit test while in this passive mode, for example the fit test outlined in Appendix A to OSHA standard § 1910.134—Fit Testing Procedures, Part I. OSHA-Accepted Fit Test Protocols. In these embodiments, the device may include the ability to augment the mask's filtering properties by turning on the fan, so that air entering the mask is filtered and/or air exiting the mask is filtered.

Methods recited herein may be carried out in any order of the recited events which is logically possible, as well as the recited order of events. Furthermore, where a range of values is provided, every intervening value between the upper and lower limit of that range and any other stated or intervening value in that stated range is encompassed within the invention. Also, any optional feature of the inventive variations described may be set forth and claimed independently, or in combination with any one or more of the features described herein.

All existing subject matter mentioned herein (e.g., publications, patents, standards, patent applications and hardware) is incorporated by reference herein in its entirety except insofar as the subject matter may conflict with that of the present invention (in which case what is present herein shall prevail). The referenced items are provided solely for their disclosure prior to the filing date of the present application. Nothing herein is to be construed as an admission that the present invention is not entitled to antedate such material by virtue of prior invention.

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise, all technical and scientific terms used herein have the same meaning as commonly understood by one of ordinary skill in the art to which this invention belongs.

This disclosure is not intended to be limited to the scope of the particular forms set forth, but is intended to cover alternatives, modifications, and equivalents of the variations described herein. Further, the scope of the disclosure fully encompasses other variations that may become obvious to those skilled in the art in view of this disclosure. The scope of the present invention is limited only by the appended claims.

1. A personal isolation system, comprising:
a passive filtration component having a mask configured for positioning over a mouth and/or nose of a user, wherein the mask has at least one portion configured to filter air passing through the at least one portion;
an active filtration component having a fan, wherein the active filtration component is configured to filter air entering or exiting the active filtration component via the fan; and
a hose fluidly coupled between the passive filtration component and the active filtration component such that the active filtration component is remote from a face of the user when in use.

2. The system of claim 1 wherein the fan is reversible such that a first direction of the fan urges filtered air from the active filtration component into the passive filtration component for inhalation by the user, and a second direction of the fan urges exhaled air from the user into the active filtration component for filtering.

3. The system of claim 1 wherein the active filtration component further comprises a high efficiency particulate air (HEPA) filter in fluid communication with the fan.

4. The system of claim 1 wherein the at least one portion of the mask comprises a filter fabricated from an electrostatic felt material.

5. The system of claim 1 wherein the fan of the active filtration component is selectively actuatable.

6. The system of claim 1 wherein a first portion of the hose is fluidly coupled to a side of the mask.

7. The system of claim 1 wherein the hose is detachably coupled to the passive filtration component.

8. The system of claim 1 wherein the mask is comprised of one or more layers.

9. The system of claim 8 wherein the mask includes at least one additional layer comprised of an electrostatic felt material.

10. The system of claim 1 wherein the active filtration component is located remote from the face and positioned upon or in proximity to a neck of the user when in use.

11. The system wherein the active filtration component is located remote from the face and positioned upon or in proximity to a body or torso of the user when in use.

12. A method of filtering air, comprising:
positioning a passive filtration component having a mask over a mouth and/or nose of a user, wherein the mask has at least one portion configured to filter air passing through the at least one portion;
positioning an active filtration component having a fan remote from a face of the user, wherein the active filtration component is configured to filter air entering or exiting the active filtration unit; and
actuating the active filtration component such that air is passed between the active filtration component and the passive filtration component via a hose fluidly coupled between.

13. The method of claim 12 wherein actuating the active filtration component comprises actuating the fan in a first direction of the fan such that filtered air is passed from the active filtration component and into the passive filtration component for inhalation by the user.

14. The method of claim 12 wherein actuating the active filtration component comprises actuating the fan in a second direction of the fan such that exhaled air from the user is passed from the passive filtration component and into the active filtration component for filtering.

15. The method of claim 12 wherein actuating the active filtration further comprises filtering the air via a high efficiency particulate air (HEPA) filter in fluid communication with the fan.

16. The method of claim 12 wherein the at least one portion of the mask comprises a filter fabricated from an electrostatic felt material.

17. The method of claim 12 wherein actuating the active filtration comprises selectively actuating the fan of the active filtration component.

18. The method of claim 12 wherein a first portion of the hose is fluidly coupled to a side of the mask.

19. The method of claim 12 wherein the hose is detachably coupled to the passive filtration component.

20. The method of claim 12 wherein the mask is comprised of one or more layers.

21. The method of claim 20 wherein the mask includes at least one additional layer comprised of an electrostatic felt material.

22. The method of claim 12 further comprising detaching the active filtration component from the passive filtration component.

23. The method of claim 12 wherein positioning the active filtration component comprises positioning the active filtration component such that the fan is positioned upon or in proximity to a neck of the user.

24. The method of claim 12 wherein positioning the active filtration component comprises positioning the active filtration component such that the fan is positioned upon or in proximity to a body or torso of the user.

25. The method of claim 12 further comprising fluidly de-coupling the active filtration component from the passive filtration component such that the passive filtration component is operable to filter inhaled and exhaled air without the active filtration component.

26. The system of claim 1 wherein the hose is fluidly de-couplable such that the passive filtration component is operable to filter inhaled and exhaled air without the active filtration component.
